(19) United States
(12) Patent Application Publication
(10) Pub. No.: US 2025/0252121 A1
(43) Pub. Date: Aug. 7, 2025

(54) LEVERAGING EXTERNAL SUMMARIES WITH LLMS

(71) Applicant: GOOGLE LLC, Mountain View, CA (US)

(72) Inventors: Fabio Sulser, Zurich (CH); Manuel Tragut, Zug (CH); Agoston Weisz, Zurich (CH); Marlia Kliuieva, Zurich (CH); Yury Stuken, Zurich (CH); llia Akolzin, Zurich (CH); Georgi Stephanov, Zurich (CH)

(21) Appl. No.: 18/433,014

(22) Filed: Feb. 5, 2024

(51) Int. Cl. G06F 16/332; G06F 16/34; G06F 40/40

(52) U.S. Cl. CPC G06F 16/3329; G06F 16/345; G06F 40/40

(57) ABSTRACT

Implementations relate to generating an external entity-summarization database to store summarized descriptions for feature(s) of entities (e.g., brand A laptop, brand B laptop, brand C SUV, etc.) that belong to one or more entity classes (e.g., laptop, SUV) using a first generative model. Implementations relate to utilizing the external entity-summarization database in generating a response responsive to a user query seeking information (e.g., recommendation of one or more entities) of a particular entity class. For instance, a summarized description for features of one or more entities that belong to the particular entity class can be identified based on querying the external entity-summarization database using a query-based embedding generated for the user query. The summarized description can be used to generate the response responsive to the user query.

### BACKGROUND

Various generative models, e.g., large language models (“LLMs”) that include hundreds of millions, billions, or tens of billions (or more) of parameters can be used to process natural language (NL) content and/or other input(s) to generate output that reflects NL content (and/or other content) that is responsive to the input(s). An LLM can be used, for instance, to process NL content of “how to change DNS settings on Acme router” to generate LLM output that reflects several responsive NL sentences such as: “First, type the router's IP address in a browser, the default IP address is 192.168.1.1. Then enter username and password, the defaults are admin and admin. Finally, select the advanced settings tab and find the DNS settings section”.

However, current utilization of an LLM suffers from one or more drawbacks. For example, processing an NL query or other input from a user can sometimes result in an inaccurate (or fabricated, “hallucinated”) response due to the LLM being trained on the basis of outdated, inadequate, or inaccurate training data. For instance, the “the default IP address is 192.168.1.1” portion of the example responsive NL sentence may be inaccurate due to the LLM being trained based on stale data that reflects a now inaccurate “192.168.1.1” as the default IP address and/or the LLM not being trained on any fresh data that reflects a new default IP address for Acme routers. As another example, a user may receive an LLM response of “Brand A has the most popular nonfat milk” that is responsive to the user's query of “what's the most popular nonfat milk,” but which includes a hallucination if brand A no longer sells any nonfat milk.

A hallucinated or inaccurate response decreases a user's trust in content generated using the LLM, which discourages the user from interacting with a computing system that implements the LLM. Moreover, for a user that continues interacting with the computing system that implements the LLM, hallucinated or inaccurate responses or answers elongate interactions between the user and the computing system (e.g., due to repeated attempts of the user in varying user prompts/inputs). This increases the consumption of various types of resources, including but not limited to, battery resources, computational resources, and network resources. This is especially true with LLMs and other generative models, which as noted above typically include large numbers of parameters, and therefore are costly to apply, computationally, temporally (e.g., they tend to introduce latency), and even in terms of energy usage.

### SUMMARY

Various implementations disclosed herein relate to building an external entity-summarization database to store one or more summarized descriptions (e.g., one or more summarized reviews). The one or more summarized descriptions, for instance, can include a summarized description that describes one or more features (e.g., battery performance, ratings in energy savings, etc.) of an entity (e.g., product A, service B, etc.) that belongs to an entity class (e.g., “laptop”, “book”, etc.). In various implementations, the summarized description that describes the one or more features of the entity can be generated based on processing one or more descriptions of the entity (e.g., that are retrieved or extracted from external data sources) using a first generative model.

These summarized descriptions can then be leveraged to enable generative models to generate fresher content than they could otherwise. Keeping an up-to-data repository of data about entity types and/or entities is beneficial because, for instance, products and services change and evolve constantly, which means information about their attributes and/or qualities, also change constantly. Generative models, by contrast, are only updated (e.g., fine-tuned) at particular times (e.g., while offline, at night, etc.), and remain more-or-less static until they are updated again later. Accordingly, having an external source of “fresh” information to leverage via in-context learning enables otherwise static generative models to generate useful and timely output.

As a non-limiting example, the one or more descriptions can include a description of the entity from data source_1 (simply referred to as “source_1”) and/or a description of the entity from data source_2 (simply referred to as “source_2”). In some implementations, the description of the entity from source_1 can describe at least one feature of the entity, and the description of the entity from source_2 can describe the same or an additional feature of the entity.

Continuing with the above non-limiting example, the description of the entity from source_1 can be content of (or extracted from) a post that is posted at a public forum and that includes comments (or reviews) exchanged by different users with respect to the entity. The comments from different users can provide different perspectives or features of the entity. The description of the entity from source_2 can be content extracted from a video, a podcast, or a website, that includes one or more comments or reviews of the entity. It is noted that, the content from source_1 (or from source_2) is not limited to descriptions herein, and can be any appropriate description of the entity from any appropriate data source.

In some implementations, to generate the summarized description that describes the one or more features of the entity, a prompt can be generated and processed using the first generative model. Continuing with the above non-limiting example, the prompt can be, for instance, “Generate a summary of the entity using <the description of the entity from source_1> and <the description of the entity from source_2>”, or “Summarize product reviews or comment from <the description of the entity from source_1> and <the description of the entity from source_2>”, etc. Such prompt can be processed as input, using the first generative model, to generate a model output from which the summarized description that describes the one or more features of the entity can be derived.

In some implementations, multiple different summaries may be generated from a single source, with each summary being focused on different features (or attributes) of the entity or entity class. For example, an article reviewing a particular model of smart phone may describe its battery life, camera quality, and durability, among other features. Not only may the article as a whole be too long to provide as input for an LLM (e.g., due to token limits, context length, etc.), but a summary of the entire article may also be too lengthy. Moreover, users may often inquire about specific features of an entity, such as “Which smart phone has the best battery life?” Accordingly, in various implementations, multiple different summaries may be generated from the same review, one focusing on batter life, another on camera quality, another on durability, and more depending on which other features are described in the review. These shorter summaries (or embeddings generated from them) are more likely to be capable of fitting into the limited context of an LLM. In addition, if a user requests information about multiple different features/attributes (e.g., “which smart phone has the best battery and is most durable?”), then the summarizations of each feature (or embeddings thereof) can be retrieved and combined (e.g., concatenated) when processed using the LLM. Consequently, the LLM output may focus on those features (battery and durability) of interest to the user, without focusing on features (e.g., camera quality) the user did not ask about.

In some implementations, an entry for the entity can be generated in an external entity-summarization database, to store the summarized description that describes the one or more features of the entity. Optionally, a summarized description embedding can be generated based on processing the summarized description that describes the one or more features of the entity (e.g., using a custom embedder). The custom embedder can be an embedding model separate from or included in the first generative model. The summarized description embedding can be included in the entry for the entity, as part of the external entity-summarization database (or be stored in association with the entry for the entity). The summarized description embedding can be, for instance, an n-dimensional, numerical vector (e.g., a vector or array of N floating point numbers) that represents semantic features of the summarized description that describes the one or more features of the entity.

In some implementations, identifier(s) (such as name, symbol, etc.) of the data source(s) (e.g., source_1 and source_2) can be included in the entry for the entity, or can be stored in association with the summarized description that describes the one or more features of the entity. Alternatively or additionally, an address (e.g., URL link) to the description of the entity from source_1 and/or an address to the description of the entity from source_2 can be included in the entry, or can be stored in association with the summarized description that describes the one or more features of the entity. Alternatively or additionally, a timestamp (e.g., publication date and/or time, post date and/or time, updated date and/or time) associated with the description of the entity from source_1 (or source_2) can be included in the entry, or can be stored in association with the summarized description that describes the one or more features of the entity. This allows responses generated or supplemented using content from the external entity-summarization database to be augmented with identifier(s) and/or timeliness of the data source(s) that provide the content or with direct access to the original content (e.g., original reviews) from the data source(s). Using the external entity-summarization database that stores summarized descriptions from reliable data sources and/or identifier(s) or addresses or timestamps associated with the data sources, chances of a user reviewing the responses as “hallucinated” can be reduced, and chances of elongated user interaction to acquire satisfying responses can be reduced. As a result, resources such as computational resources, battery resources, and network resources associated with data transfer and processing can be reduced.

In some implementations, more than one summarized description can be generated. As a working example, a summarized description that describes one or more features of a first entity that belongs to a first entity class can be generated, e.g., based on processing one or more descriptions of the first entity that are from one or more data sources, using the first generative model. A summarized description that describes one or more features of a second entity that belongs to the first entity class can be generated, e.g., based on processing one or more descriptions of the second entity, that are from one or more data sources, using the first generative model. The second entity may be different from the first entity.

In the above working example, optionally, an entry for the first entity can be generated in the external entity-summarization database, and an entry for the second entity can be generated in the external entity-summarization database. The entry for the first entity can store, for instance, the summarized description that describes one or more features of the first entity that belongs to the first entity class and/or a summarized description embedding generated based on processing the summarized description that describes one or more features of the first entity. The entry for the second entity can store, for instance, the summarized description that describes one or more features of the second entity that belongs to the first entity class (or a different entity class) and/or a summarized description embedding generated based on processing the summarized description that describes one or more features of the second entity.

Optionally, in case the first and second entities belong to the same entity class (i.e., the first entity class), instead of generating separate entries for the first entity and for the second entity, a single entry can be generated in the external entity-summarization database for the first entity class. For example, the single entry can include a first portion identifying the first entity class, a second portion that corresponds to the summarized description that describes one or more features of the first entity (and/or associated summarized description embedding, identifier(s) of associated data source(s), address(es) to the associated data source(s) or content extracted therefrom, etc.). The single entry can include a third portion that corresponds to the summarized description that describes one or more features of the second entity (and/or associated summarized description embedding, identifier(s) of associated data source(s), address(es) to the associated data source(s) or content extracted therefrom, etc.).

Alternatively, the single entry can identify the first entity class and include a concatenated summarization description of descriptions for all entities that belong to the first entity class. In some implementations, the concatenated summarization description of descriptions for all entities that belong to the first entity class (shortly as “the concatenated summarization description for the first entity class”) can be generated based on the summarized descriptions that each describe one or more features of a respective entity (out of all entities) that belongs to the first entity class. For instance, assuming the first entity and the second entity are the entities that belong to the first entity class, the concatenated summarization description for the first entity class can be generated based on the summarized description that describes one or more features of the first entity (that belongs to the first entity class), and based on the summarized description that describes one or more features of the second entity (that belongs to the first entity class).

In some implementations, the concatenated summarization description for the first entity class can be generated based on processing descriptions that respectively describe entities (e.g., entity_A1, entity_A2, entity_A3) that belong to the first entity class and that are collected from different data sources, e.g., using the first generative model. For instance, a prompt of “Summarize <the description of entity_A1 from source_1> <the description of entity_A1 from source_2> <the description of entity_A2 from source_1> <the description of entity_A3 from source_3>” can be generated. The generated prompt can be processed as input, using the first generative model, to generate a model output from which the concatenated summarization description for entities (e.g., entity_A1, entity_A2, entity_A3) that belong to the first entity class is derived. It is noted that, one or more additional single entries can be generated and the total number of entries each for a corresponding entity class can be any applicable number and is not limited to descriptions herein. For instance, an additional single entry can be generated for a second entity class that is different from the first entity class.

Alternatively or additionally, in some implementations, different entries can be generated in the external entity-summarization database each storing a summarized description that summarizes a distinct feature (or perspective) of a single entity. For instance, given the single entity of “phone X”, the external entity-summarization database can include an entry storing a summarized description S1 that summarizes a first feature (e.g., camera performance) of the entity of “phone X” and/or an embedding generated to numerically represent the summarized description S1. The external entity-summarization database can include an additional entry storing a summarized description S2 that summarizes a second feature (e.g., battery performance) of the entity of “phone X” and/or an embedding generated to numerically represent the summarized description S2. The summarized description (e.g., S1 or S1) that summarizes the first or second feature (e.g., camera or battery performance) of the entity of “phone X” can be generated based on summarizing content (e.g., article, post, video, etc.) retrieved from a single resource, or from different resources, using, e.g., the first generative model.

In some implementations, entries each describing a distinct feature of the same entity can be grouped together, or stored in association with each other, in the external entity-summarization database. In some implementations, entries each describing a distinct feature of a first entity and entries each describing a distinct feature of a second entity that belongs to the same entity class as the first entity can be grouped together in the external entity-summarization database.

In some implementations, the first generative model can be a large language model (LLM) that includes at least hundreds of millions of parameters. In some of those implementations, the LLM includes at least billions of parameters, such as one hundred billion or more parameters. In some additional or alternative implementations, the LLM is a sequence-to-sequence model, is Transformer-based, and/or can include an encoder and/or a decoder. One non-limiting example of the LLM is GOOGLE'S Pathways Language Model (PaLM). More non-limiting examples of the LLM (or more generally, generative models) are GOOGLE'S Language Model for Dialogue Applications (LaMDA) or Gemini.

In some implementations, a set of external data sources may be monitored to retrieve, for each of a plurality of entity classes, descriptions (e.g., public reviews) that describe one or more features, attributes, and/or functions of one or more entities that belong to the respective entity class, in order to build the external entity-summarization database. As a non-limiting example, the set of external data sources can include one or more forums, one or more content-sharing platforms/apps that share videos (images, natural language content, etc.), one or more podcast-hosting platform (e.g., that hosts podcasts), and/or one or more websites (e.g., that share shopping reviews, book reviews, movies review, or other types of reviews or content). In some implementations, the set of external data sources can be selected for monitoring based on factors such as category, history of establishment, popularity, rating of reliability or authorization, timeliness, etc.

By searching and monitoring external data sources (e.g., using natural language keyword(s) that each identify an entity class or entities thereof) to retrieve, for each of a plurality of entity classes, descriptions that describe one or more features of one or more entities that belong to a respective entity class, different features or aspects for each entity or each entity classes of the plurality of entity classes can be extracted, aggregated/summarized, and stored in the external entity-summarization database. This results in caching of pre-generated summarized descriptions or recommendations of entities and/or entity classes to supplement or augment the inherent knowledge of a second generative model acquired during pre-training of the second generative model. As a result, accuracy of content generated using the second generative model in response to a user query (e.g., that seeks recommendation of entities for an entity class) can be improved, and the risk of the generated content including a hallucinated response can be reduced.

It is noted that the second generative model can be the same as, or different from the first generative model. As noted previously, the first and/or second generative models may not be trained constantly or even frequently. Accordingly, maintaining an up-to-date external entity-summarization database enables the otherwise relatively static generative models to be “conditioned” at each turn using up-to-date information (e.g., summarized descriptions each summarize an entity class, an entity, or a feature of an entity). Put another way, updating the external entity-summarization database enables “in-context” learning where external data that is not yet trained into the generative model is nonetheless incorporated into the input prompt so that the generative model is able to generate “fresher” content.

Further, by summarizing descriptions for the same feature of an entity, for the same entity, or the same entity class (using the first generative model), the length of the summarized descriptions in the external entity-summarization database can be reduced as compared to descriptions extracted from the external data sources. This way, the length of the summarized description may be controlled so as to not exceed a predefined maximum length (e.g., token limit, context length) processable using the second generative model or the custom embedder. This not only reduces the consumption of memory resources to store the external entity-summarization database, but also ensures that the summarized descriptions in the external entity-summarization database can be processed/utilized using the second generative model or the custom embedder. Moreover, generating multiple different feature-specific summaries (e.g., one summary for battery life, another for camera quality, another for durability, etc.) from a single data source results in each individual summary being shorter, and consequently, less likely to exceed a context length of the generative model.

Various implementations disclosed herein further relate to utilizing the external entity-summarization database and/or the second generative model in providing a response to a user query that requests information (e.g., recommendation, review, etc.) for an entity or an entity class. In some implementations, the second generative model can be different from the first generative model. In some other implementations, the second generative model can be the same as the first generative model, while prompts processed using the first and second generative models can be different. The second generative model can be an additional large language model (“LLM”) including hundreds of millions of parameters, billions of parameters, or tens or hundreds of billions of parameters, etc. In some implementations, the additional LLM is a sequence-to-sequence model, is Transformer-based, and/or can include an encoder and/or a decoder.

In various implementations, a user query that seeks information about a particular entity class can be received. As a non-limiting example, the user query can be, for instance, a textual or audible input of “what SUV possesses superior towing capacity”. In response to receiving the user query, a search can be performed on the external entity-summarization database, to acquire one or more particular summarized descriptions of one or more features (e.g., towing capacity) of one or more entities (e.g., SUV1, SUV2, etc.) that belong to the entity class (e.g., “SUV”), or to acquire a concatenated summarization description for the entity class. The one or more particular summarized description for the entity class of “SUV” (or the concatenated summarization description for the entity class) can be returned as a search result responsive to the user query and be forwarded to the second generative model for further processing.

In some implementations, the search can be performed by querying the external entity-summarization database based on the user query. In some other implementations, the search can be performed by querying the external entity-summarization database based on the user query and contextual data (e.g., a chat history, a portion of human-to-computer dialog) associated with the user query.

In some implementations, the search can be an embedding search, where a query embedding (e.g., [0.0013567 . . . , −0.2358598 . . . , . . . , . . . ]) for the user query (e.g., “what SUV possesses superior towing capacity”) is generated based on the user query and/or the contextual data (e.g., chat history). The query embedding for the user query can be compared with summarized description embeddings determined or pre-stored for all summarized descriptions (for the different entity classes) in the external entity-summarization database. The comparison can result in, for instance, identification of one or more summarized description embeddings determined for the one or more particular summarized descriptions (“users from forum A recommend SUV1 as possessing the best towing capacity” and “a review from video B mentions SUV2 as recommended for tow”).

It is noted that in case the external entity-summarization database stores concatenated summarization descriptions for entity classes instead of summarized descriptions of entities belonging to different entity classes, the comparison can result in identification of a particular concatenated summarization description embedding determined for a particular concatenated summarization description (e.g., “users from forum A recommend SUV1 as possessing the best towing capacity; a review from video B mentions SUV2 as recommended for tow”).

The query embedding for the user query can be generated based on processing the user query (and/or associated contextual data) using the custom embedder. Each of the summarized description embeddings (or concatenated summarization description embeddings) can be generated based on processing a corresponding summarized description (or a corresponding concatenated summarization description) using the custom embedder. The query embedding for the user query and each of the summarized description embeddings (or concatenated summarization description embeddings) can in some cases be vectors of the same dimension (e.g., N dimensions). Distances between the query embedding for the user query and the summarized description embeddings can be calculated using techniques such as cosine similarity and/or Euclidean distance. Based on the distances, the summarized description embeddings can be ranked and one or more top ranked summarized description embeddings (that corresponds to one or more shortest distances which indicate high similarity) can be selected.

In some implementations, an input prompt can be assembled using the user query and the particular summarized description. For instance, the input prompt can include the user query, the particular summarized description (or an embedding thereof), and an instruction to generate a response to the user query in view of the particular summarized description. As another example, the input prompt can include the user query, and an instruction to generate a response to the user query in view of the particular summarized description and the contextual data associated with the user query.

The input prompt can be processed using the aforementioned second generative model to generate a response to the user query (e.g., “SUV1 and SUV2 may be good shopping options in view of towing capacity”, or “SUV1 and SUV2 may be good shopping options in view of towing capacity, click here (link1, link2) to see original reviews from forum A and video B”, etc.). The response can be rendered audibly and/or visually, in response to the user query. The response can include, for instance, one or more recommendations, each recommending an entity within the particular entity class.

In various implementations, a user query that seeks information about a particular entity or about a particular feature of an entity can be received. By summarizing descriptions for the same entity, for the same entity class, and/or for the same feature of an entity, summarized descriptions have different levels of granularity are acquired. An external entity-summarization database pre-caching or storing summarized descriptions having different levels of granularity enables responsive content generated using the second generative model to be more precisely related to user queries that may seek information with different levels of details.

Various implementations provide a method implemented using one or more processors. In various implementations, the method includes: receiving a user query that seeks information about an entity class; and searching, based at least on the user query, an external entity-summarization database, to acquire a summarized description of one or more of the features of one or more entities of the entity class. In some implementations, the external entity-summarization database includes one or more entries each storing a summarized description of one or more features of a respective entity of the entity class. In some implementations, the summarized description of the respective entity is generated based on summarizing one or more public descriptions that describe multiple features of the respective entity, using one or more generative models.

In various implementations, the method further includes: generating a prompt based on the user query and the summarized description of one or more features of the entity; processing the prompt as input, using one or more of the generative models, to generate a model output from which a response to the user query is derived; and causing the response to the user query to be rendered at an output device.

In some implementations, the user query seeks a recommendation of one or more entities of the entity class, and wherein the response to the user query includes a recommendation of one or more particular entities of the entity class. In some implementations, the external entity-summarization database identifies one or more data sources for the one or more public descriptions, respectively; and the one or more data sources are associated with the summarized description for the respective entity. In some implementations, the rendered response to the user query presents a particular data source for the recommendation to the particular product that is identified in the summarized description of the entity. In some implementations, the rendered response to the user query includes a selectable element that, when selected, causes the particular data source to be rendered.

In some implementations, the one or more public descriptions include a first public review that reviews the respective entity from a public data source, and a second public review that reviews the respective entity from an additional public data source that is different from the public data source.

In some implementations, searching, based at least on the user query, the external entity-summarization database to acquire the summarized description of the entity comprises: generating a first numeric embedding based on the user query and/or context data associated with the user query; and searching the external entity-summarization database using the first numerical embedding, to identify the summarized description of the entity. In some implementations, searching the external entity-summarization database using the first numerical embedding comprises: for each respective summarized description in the external entity-summarization database, calculate a distance between the first numeric embedding and a numeric embedding for the respective summarized description; and selecting one summarized description from the external entity-summarization database that satisfies a distance threshold as the summarized description of the entity.

In some implementations, the user query is received during an interactive chat; and the context data associated with the user query includes at least a portion of a chat history of the interactive chat that precedes the user query.

In some implementations, the external entity-summarization database includes a respective numeric embedding for the summarized description for the respective entity, stored in association with the summarized description for the respective entity.

In some implementations, the generative model is trained to summarize reviews from one or more public data sources. In some implementations, the external entity-summarization database is updated in real-time based on detection of an update to the reviews published at the one or more public data sources.

The preceding is presented as an overview of only some implementations disclosed herein. These and other implementations are disclosed in additional detail herein. For example, additional and/or alternative implementations are disclosed herein such as training the second generative model to determine when to access the external entity-summarization database to generate a response to a user query using content extracted from the external entity-summarization database, or using a classifier to classify the user query in order to determine whether to access the external entity-summarization database to generate the response.

Various implementations can include a non-transitory computer readable storage medium storing instructions executable by a processor to perform a method such as one or more of the methods described herein. Yet other various implementations can include a system including memory and one or more hardware processors operable to execute instructions, stored in the memory, to perform a method such as one or more of the methods described herein.

### BRIEF DESCRIPTION OF THE DRAWINGS

FIG. 1A depicts a block diagram of an example environment that demonstrates various aspects of the present disclosure, and in which some implementations disclosed herein can be implemented.

FIG. 1B illustrates an example scenario where an entity summarization database is built and utilized in responding to a user query, in accordance with various implementations disclosed herein.

FIG. 2A depicts an example user query, in accordance with various aspects of the present disclosure.

FIG. 2B depicts an example response responsive to the user query in FIG. 2A, in accordance with various aspects of the present disclosure.

FIG. 2C depicts an example entity summarization database utilized in generating a response, in accordance with various aspects of the present disclosure.

FIG. 2D depicts another example entity summarization database utilized in generating a response in FIG. 2B, in accordance with various aspects of the present disclosure.

FIG. 2E depicts a further example entity summarization database utilized in generating a response, in accordance with various aspects of the present disclosure.

FIG. 2F depicts an example updated entity summarization database based on applying an update to the entity summarization database in FIG. 2D, in accordance with various aspects of the present disclosure.

FIG. 2G depicts an example response responsive to the user query in FIG. 2A, utilizing the updated entity summarization database in FIG. 2F, in accordance with various aspects of the present disclosure.

FIG. 2H depicts user access to original content from an external data source via a chat interface, in accordance with various aspects of the present disclosure.

FIG. 3 depicts a flowchart illustrating an example method of generating and/or updating entity summarization database, in accordance with various aspects of the present disclosure.

FIG. 4A and FIG. 4B depict a flowchart illustrating an example method of responding to a user query using an entity summarization database, in accordance with various aspects of the present disclosure.

FIG. 5 depicts an example architecture of a computing device, in accordance with various implementations.

### DETAILED DESCRIPTION

The following description with reference to the accompanying drawings is provided for understanding of various implementations of the present disclosure. It's appreciated that different features from different embodiments may be combined with and/or exchanged for one another. In addition, those of ordinary skill in the art will recognize that various changes and modifications of the various embodiments described herein can be made without departing from the scope and spirit of the present disclosure. Descriptions of well-known or repeated functions and constructions may be omitted for clarity and conciseness.

The terms and words used in the following description and claims are not limited to the bibliographical meanings, and are merely used by the inventor to enable a clear and consistent understanding of the present disclosure. Accordingly, it should be apparent to those skilled in the art that the following description of various embodiments of the present disclosure is provided for the purpose of illustration only and not for the purpose of limiting the present disclosure as defined by the appended claims and their equivalents.

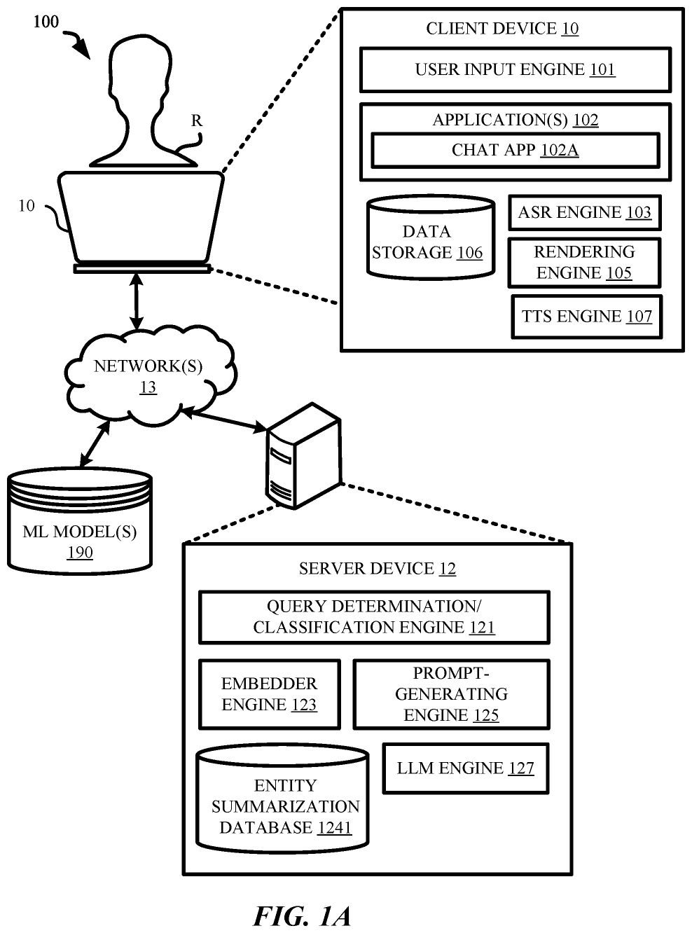

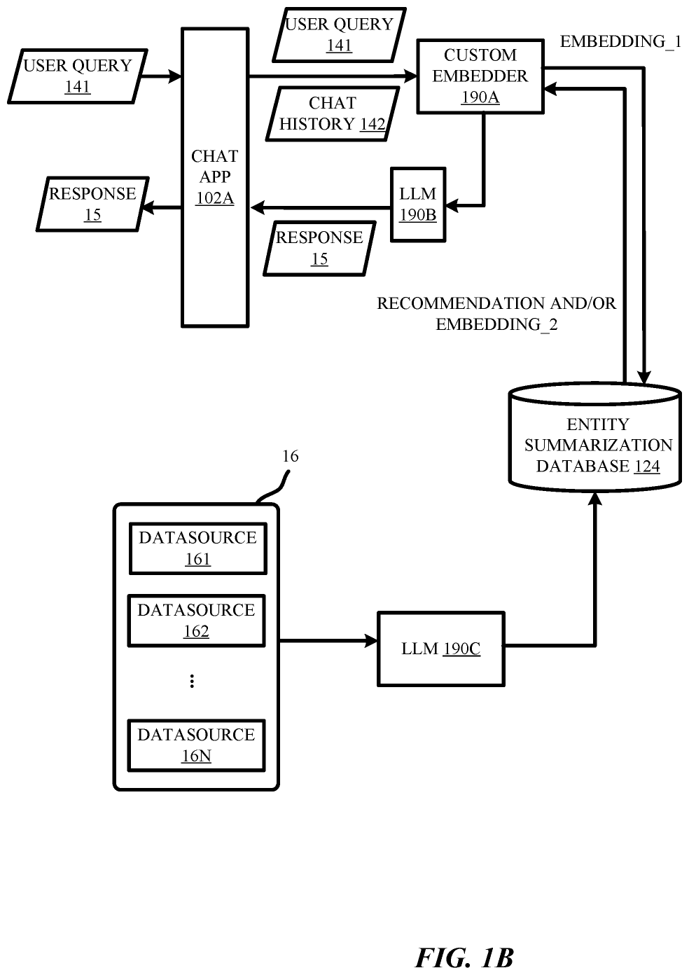

FIG. 1A is a block diagram of an example environment 100 that demonstrates various aspects of the present disclosure, and in which implementations disclosed herein may be implemented. As shown in FIG. 1A, the environment 100 can include a client computing device 10 (“client device”), and a server computing device 12 (“server device”) in communication with the client computing device 10. The server computing device 12 can communicate with the client computing device 10 via one or more networks 13.

The one or more networks 13 can include, for example, a local area network (LAN), a wide area network (WAN) such as the Internet, and/or any other appropriate network. In some implementations, the client computing device 10 can include, or other access one or more machine learning (ML) models 190 via the one or more networks 13. Additionally or alternatively, the server computing device 12 in communication can include, or other access one or more machine learning (ML) models 190 via the one or more networks 13. The one or more ML models 190 can include, for instance, a custom embedder 190A, an LLM model 190B, and/or an LLM model 190C (as seen in FIG. 1B).

The client computing device 10 can be, for example, a desktop computing device, a laptop computing device, a tablet computing device, a mobile phone computing device, a computing device of a vehicle (e.g., an in-vehicle entertainment or navigation system), an interactive speaker, a smart appliance such as a smart television, and/or a wearable apparatus that includes a computing device (e.g., glasses having a computing device, a smart watch, a virtual or augmented reality computing device), and the present disclosure is not limited thereto.

In various implementations, the client computing device 10 can include software component(s) such as a user input engine 101 and/or hardware component(s) such as input and output (I/O) device(s). The I/O device(s) can include, for instance, one or more speakers and one or more microphones. In some implementations, the I/O device(s) can include other hardware component(s) such as a display to visually render natural language content and/or visual content, and/or a keyboard (not depicted) to receive typed input, touch input, or other types of input.

The user input engine 101 can be configured to detect user input provided by a user of the client computing device 10 using one or more of the input devices. For example, the aforementioned keyboard can receive typed input. As another example, the client computing device 10 can be equipped with a mouse (or one or more hardware buttons) to receive a user click that selects one or more graphical user interface (GUI) elements that is rendered visually at a user interface of the client computing device 10. Additionally, or alternatively, the one or more microphones can capture audio data, such as audio data corresponding to spoken utterances of the user or other sounds in an environment of the client computing device 10. Additionally, or alternatively, the client computing device 10 can be equipped with one or more vision components (e.g., a camera) that are configured to capture vision data corresponding to images and/or movements (e.g., gestures, etc.) detected in a field of view of one or more of the vision components. Additionally, or alternatively, the client computing device 10 can be equipped with one or more touch sensitive components (e.g., a stylus, a touch screen, a touch panel, etc.) that are configured to capture signal(s) corresponding to touch input directed to the client computing device 10.

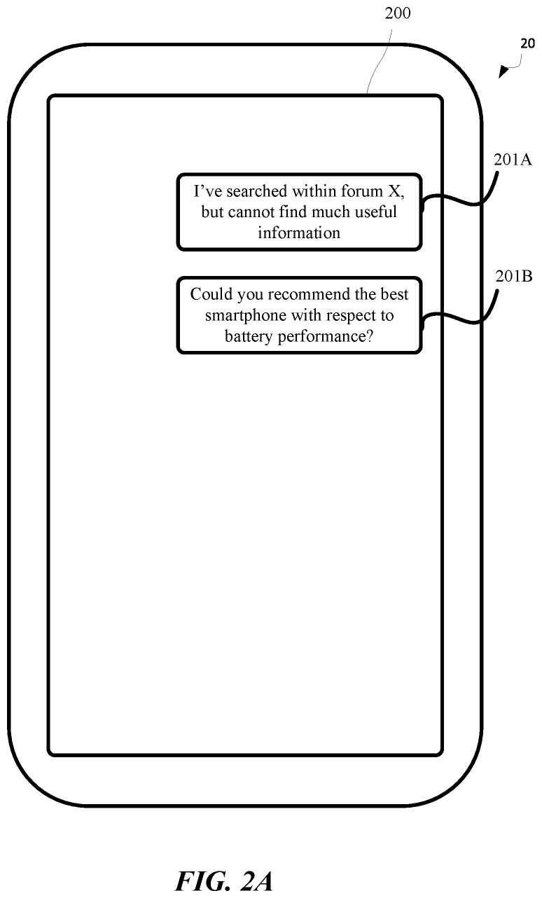

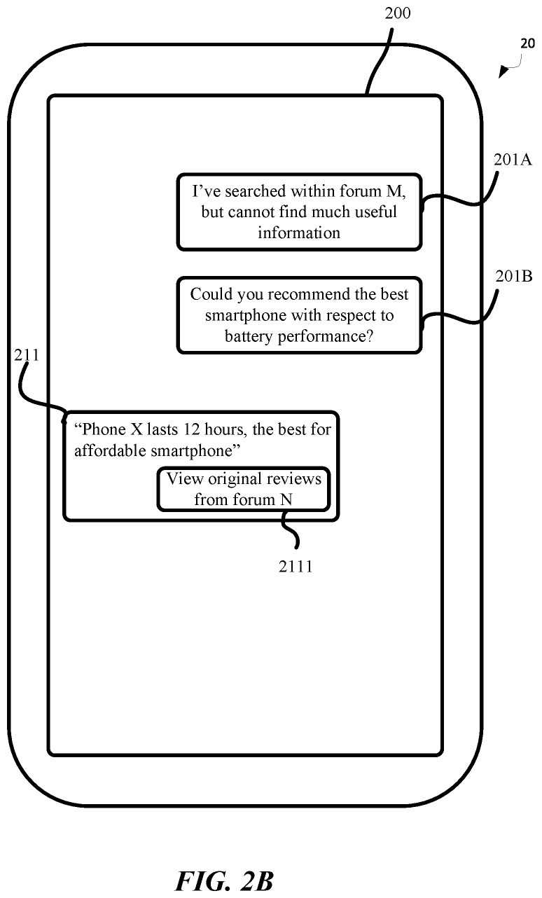

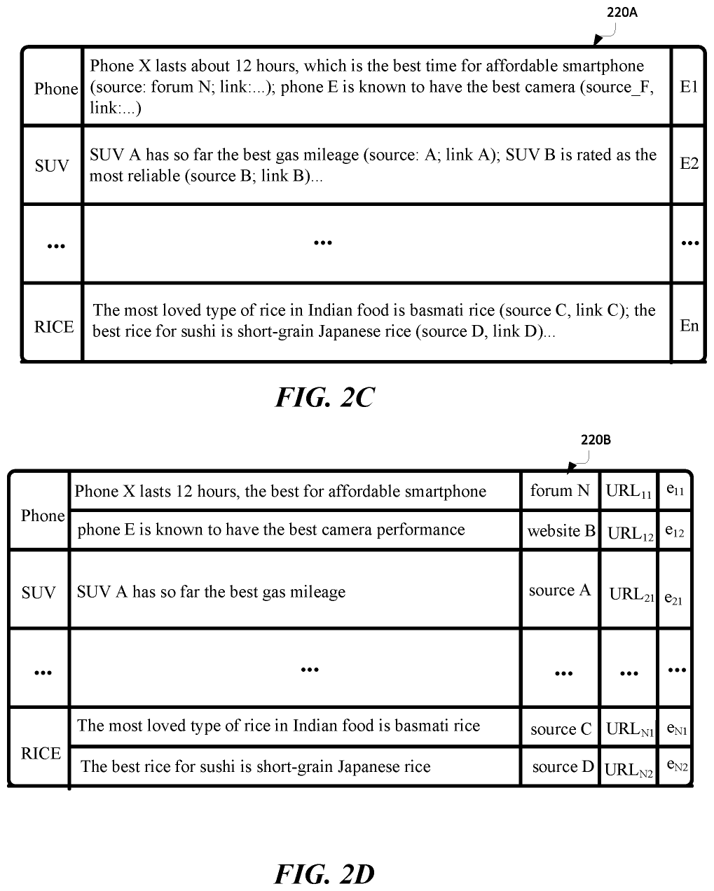

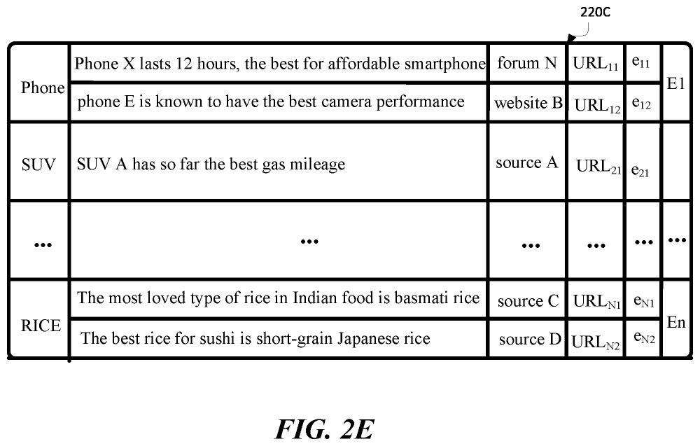

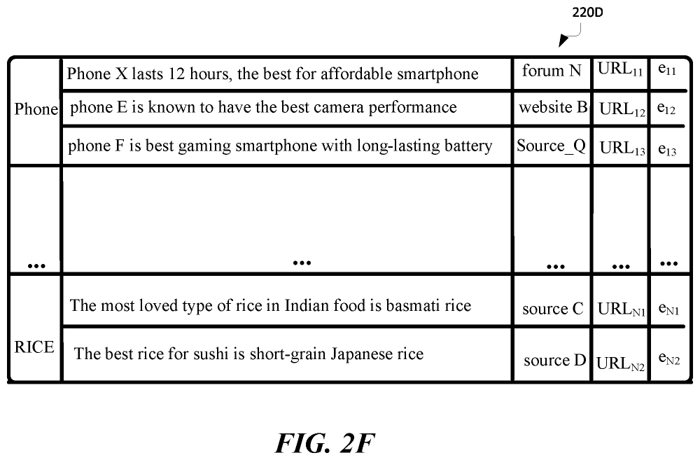

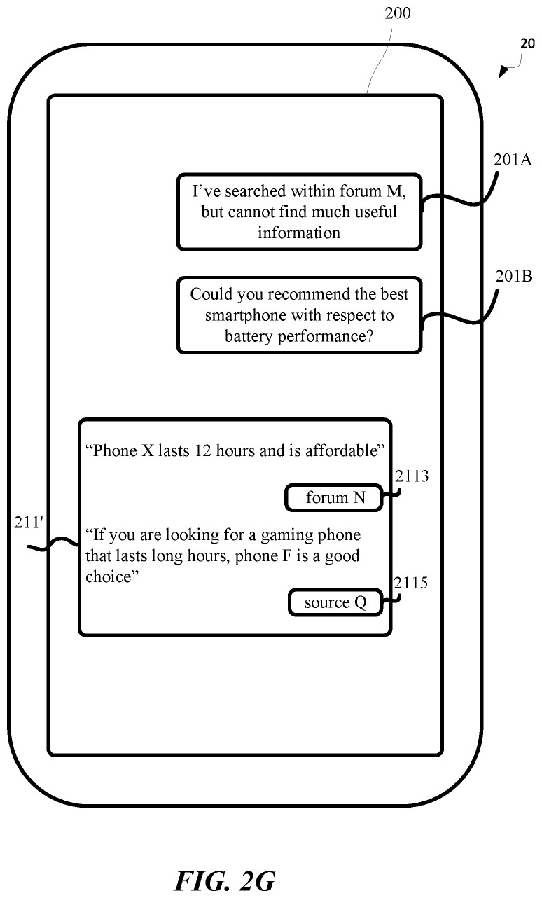

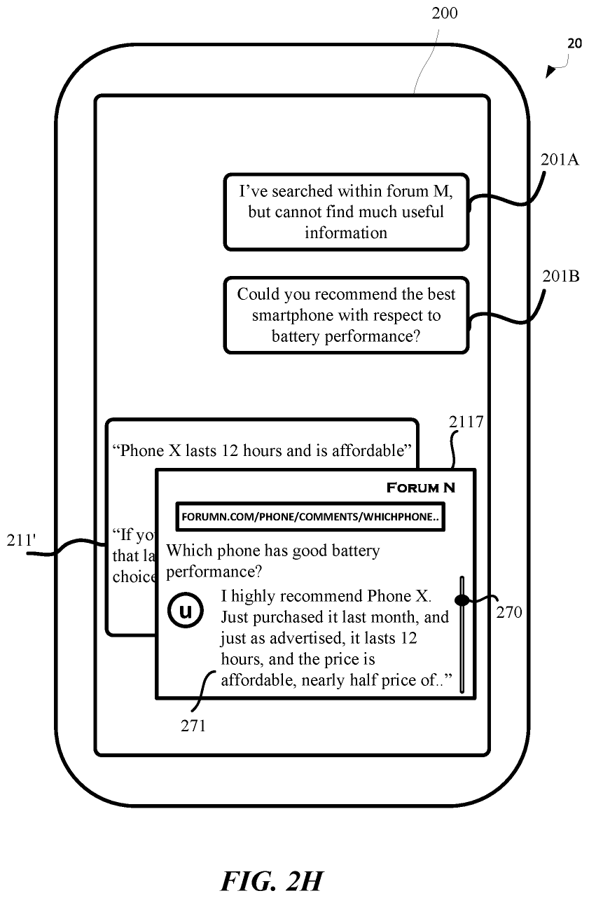

In various implementations, the client computing device 10 can further include one or more applications 102. The one or more applications 102 can include, for instance, a chat application 102A. In some implementations, the chat application 102A can include or otherwise access, for instance, an automatic speech recognition (ASR) engine 103. The ASR engine 103 can process audio data that captures a spoken utterance to generate a speech recognition of the spoken utterance. In some implementations, the audio data that captures the spoken utterance can be determined as being directed to the chat application 102A. For instance, the audio data that captures the spoken utterance can be determined as being directed to the chat application 102A based on the audio data that captures the spoken utterance being received while the chat application 102A is running at the client computing device 10. In this case, the speech recognition of the spoken utterance can be rendered visually (e.g., using a rendering engine 105) via a chat interface (e.g., 200 in FIG. 2A) of the chat application 102A.

In some implementations, optionally, the chat application 102A can include, or otherwise access, a query determination/classification engine 121, an embedder engine 123, a prompt-generating engine 125, and/an LLM engine 127. The query-determination/classification engine 121 can determine, for instance, whether the aforementioned speech recognition of the spoken utterance (or a typed user input received via the chat application 102A) includes a user query that seeks information about an entity class (e.g., a type of products, such as smart phone) or a particular entity (e.g., a particular movie). For instance, the query-determination/classification engine 121 can determine that the speech recognition of the spoken utterance (or a typed user input) includes a user query that seeks information about an entity class (or a particular entity) based on determining that the speech recognition of the spoken utterance (or the typed user input) includes one or more keywords (e.g., “can you recommend”, “what is the best . . . ”). As another example, the query-determination/classification engine 121 can process the speech recognition of the spoken utterance (or the typed user input) using a classification model to classify whether the speech recognition of the spoken utterance (or the typed user input) includes a user query that seeks information about an entity class (or a particular entity). In some implementations, in response to determining that the speech recognition of the spoken utterance (or the typed user input received via the chat application 102A) includes a user query that seeks information about an entity class (or an entity), the speech recognition of the spoken utterance (or the typed user input) can be forwarded to the embedder engine 123.

In some implementations, the embedder engine 123 can be in communication with the custom embedder 190A (a custom embedding model). The speech recognition of the spoken utterance (or the typed user input) and/or contextual data (e.g., a chat history or a portion thereof) can be processed by the embedder engine 123 using the custom embedder 190A, to generate a query-based embedding (sometimes referred to as “query embedding”). The query-based embedding can be an n-dimensional numerical vector that captures semantic features of input data (e.g., the speech recognition of the spoken utterance and a portion of a chat history preceding the speech recognition) to be provided to the custom embedder 190A (as seen in FIG. 1B).

The query-based embedding can be utilized to query an external entity-summarization database 1241. The external entity-summarization database 1241 can be stored at the server device 12 or the client computing device 10, or shared between the server device 12 and the client computing device 10. The external entity-summarization database 1241 can include entries about any number of entities and/or entity classes. The entries can include, for instance, one entry for a first entity class (e.g., SUV) that includes a first concatenated summarization description for the first entity class, another entry for the second entity class (e.g., “laptop”) that includes a second concatenated summarization description for the second entity class, and so on.

In some implementations, the first concatenated summarization description for the first entity class can include, for instance, a first portion that identifies the first entity class, one or more additional portions each correspond to a summarized description of a respective/distinct entity that belongs to the first entity class. The second concatenated summarization description for the second entity class can include, for instance, a first portion that identifies the second entity class, one or more additional portions each correspond to a summarized description of a respective/distinct entity that belongs to the second entity class. Entries for other entity classes may be similar. In some implementations, a portion of an entry that corresponds to a summarized description of an entity (which can belong to the first entity class, second entity class, or other entity class) can be divided into one or more sub-portions each having a summarized description that describes a distinct feature of the entity. This way, the external entity-summarization database 1241 can pre-cache or store summarized descriptions having different levels of granularity. This facilitates extraction of information, from the external entity-summarization database 1241, that is responsive to user queries that may seek information with different levels of details.

In some implementations, the first entry for the first entity class can include a first concatenated summarization embedding (e.g., an n-dimensional numerical vector) generated based on the first concatenated summarization description for the first entity class (e.g., using the custom embedder 190A). The first summarization embedding can be stored in association with the first concatenated summarization description for the first entity class. The second entry for the second entity class can include a second concatenated summarization embedding (e.g., an n-dimensional numerical vector) generated based on the second concatenated summarization description for the second entity class (e.g., using the custom embedder 190A). The second entry for the second entity class can be stored in association with the second concatenated summarization description for the second entity class. Entries for other entity classes may be similar.

Optionally, the external entity-summarization database can include a first concatenated summarization description for a first entity class, a second concatenated summarization description for a second entity class, . . . , and an N^{th} concatenated summarization description for an N^{th} first entity class (where N is a positive integer). In this case, optionally, the external entity-summarization database can include a first concatenated summarization embedding can be stored in association with the first concatenated summarization description for the first entity class, a second concatenated summarization embedding can be stored in association with the second concatenated summarization description for the second entity class, . . . , and an N^{th} concatenated summarization embedding (e.g., an n-dimensional numerical vector generated using the custom embedder 190A) can be stored in association with the N^{th} concatenated summarization description for the N^{th} entity class.

In some implementations, querying the external entity-summarization database 1241 using the query-based embedding is realized by comparing the query-based embedding with each of the first concatenated summarization embedding, the second concatenated summarization embedding, . . . , and the N^{th} concatenated summarization embedding, respectively. For instance, a first similarity score can be calculated based on comparing the query-based embedding with the first concatenated summarization embedding, a second similarity score can be calculated based on comparing the query-based embedding with the second concatenated summarization embedding, . . . , and an N^{th} similarity score can be calculated based on comparing the query-based embedding with the N^{th} concatenated summarization embedding. The first, second, . . . , or N^{th} similarity scores can each be, for instance, a cosine distance between the query-based embedding with a corresponding concatenated summarization embedding. In some implementations, the embedder engine 123 can rank the first, second, . . . , and N^{th} similarity scores, and determine, for instance, a particular concatenated summarization embedding (and/or an associated particular concatenated summarization description for a particular entity class) that the highest similarity score corresponds to, as matching/being responsive to the query-based embedding.

In some implementations, an input prompt can be generated (e.g., using the prompt-generating engine 125) to include the user query and/or the particular concatenated summarization description for the aforementioned particular entity class. The input prompt can be processed by the LLM engine 1025 using the LLM model 190B (simply referred to as “LLM 190B”), to generate a model output from which a response (responsive to the user query) is derived. In some implementations, the rendering engine 127 can cause the generated response to be rendered (for instance, at the chat interface 200) in response to the speech recognition of the user utterance (or the typed input) as described above.

The LLM model 190B, for instance, can include at least hundreds of millions of parameters. The LLM model 190B can alternatively include at least billions of parameters, such as one hundred billion or more parameters. In some implementations, the LLM 190B is a sequence-to-sequence model, is Transformer-based, and/or can include an encoder and/or a decoder. One non-limiting example of an LLM is GOOGLE'S Pathways Language Model (PaLM). Another non-limiting example of an LLM is GOOGLE'S Language Model for Dialogue Applications (LaMDA).

In some implementations, the custom embedder 190A can be trained to generate embeddings that are processable using the LLM model 190B. In some implementations, the particular summarization embedding can be processed using the LLM model 190B to generate the model output from which the response (responsive to the aforementioned user query) is derived. For instance, the LLM model 190B can include an encoder (and sometimes more than one encoder), and the particular summarization embedding can be processed using the encoder of the LLM model 190B.

In some implementations, as described above, the external entity-summarization database 1241 can include a first concatenated summarization description for a first entity class, a second concatenated summarization description for a second entity class, . . . , and an N^{th} concatenated summarization description for an N^{th} first entity class. The first entity class, the second entity class, . . . , and the N^{th} entity class can be different from one another. In some other implementations, alternatively or additionally, the external entity-summarization database 1241 can include a first set of summarized descriptions each summarizes feature(s) of a first set of entities that belong to the first entity class, a second set of summarized descriptions each summarizes feature(s) of a second set of entity that belong to the second entity class, . . . , and a set of N^{th} summarized descriptions each summarizes feature(s) of an N^{th} set of entities that belongs to the N^{th} entity class.

Optionally, a first set of summarized description embeddings can be generated (e.g., using the custom embedder 190A) each for a respective summarized description that summarizes features of a respective entity that belongs to the first entity class. Optionally, a second set of summarized description embeddings can be generated (e.g., using the custom embedder 190A) each for a respective summarized description that summarizes features of a respective entity that belongs to the second entity class. This may continue until an N^{th} set of summarized description embeddings are generated (e.g., using the custom embedder 190A) each for a respective summarized description that summarizes features of a respective entity that belongs to the N^{th} entity class.

As an example, given a total number of p entities that belong to the first entity class (or another entity class), a summarized description embedding E_A1 can be generated (e.g., using the custom embedder 190A) for a summarized description that summarizes features of entity A_1 that belongs to the first entity class. A summarized description embedding E_A2 can be generated (e.g., using the custom embedder 190A) for a summarized description that summarizes features of entity A_2 that belongs to the first entity class. This may continue until a summarized description embedding E_Ap can be generated (e.g., using the custom embedder 190A) for a summarized description that summarizes features of entity A_p that belongs to the first entity class (where p is a positive integer).

In the above example, the summarized description embedding E_A1 can be stored in the external entity-summarization database 1241 in association with the summarized description that summarizes features of entity A_1 that belongs to the first entity class. The summarized description embedding E_A2 can be stored in the external entity-summarization database 1241 in association with the summarized description that summarizes features of entity A_2 that belongs to the first entity class. The summarized description embedding E_Ap can be stored in the external entity-summarization database 1241 in association with the summarized description that summarizes features of entity A_p that belongs to the first entity class.

In some implementations, the LLM model 190B can be trained to determine whether to retrieve additional information from the external entity-summarization database 1241 in generating a response to a user query. For instance, the LLM model 190B can be trained or fine-tuned using a plurality of training instances. The plurality of training instances can include, for instance, logs of chat dialogs where a user provided feedback that suggested additional information should have been retrieved. For example, if the user the explicitly identifies a hallucination or out-of-date information (e.g., “after the update that phone no longer has that issue”) during a chat interaction with a generative model, that chat log may be used as a training example to fine-tune the generative model so that when similar initial inputs are received, the generative model may generate output suggesting that additional information should be retrieved, e.g., from external entity-summarization database 1241, and used as part of a subsequent prompt for the generative model. As another example, if after issuing an initial query and receiving a responsive output, the user asks for an update based on one or more external sources, the user's initial query may be used to demonstrate to the generative model an example of where additional information should have been retrieved.

In some implementations, the plurality of training instances can be automatically generated using one or more summarized descriptions from the external entity-summarization database 1241.

By using the plurality of training instances to train or fine tune the LLM 190B, the LLM 190B can determine whether additional information (e.g., summarized descriptions for entities and/or embeddings thereof, or concatenated summarization descriptions for entity classes and/or embeddings thereof) is necessary or warranted to generate a response (e.g., a recommendation text) responsive to a user query. In case the additional information is necessary or warranted to generate a response to a user query, the custom embedder 190A can provide a query-based embedding (as described above) that is generated based on the user query (and/or associated contextual data), to the external entity-summarization database 1241, to acquire the additional information (e.g., summarized description(s) or an embedding thereof).

In some implementations, the chat application 102A can include, but does not necessarily need to include, a NLU engine (not depicted) to determine semantic meaning(s) of a text (e.g., the aforementioned typed input or speech recognition of the user utterance) and/or the audio (e.g., the aforementioned audio data capturing the spoken utterance). The NLU engine can decompose the determined semantic meaning(s) to determine intent(s) and/or parameter(s) for an action (e.g., generating a response) performable via the chat application 102A. For instance, the NLU engine can process natural language content of “weather today?”, to determine a natural language understanding (NLU) intent of “search” and/or parameters (e.g., “weather” and “today”) for an action of searching the Internet for weather today. In some implementation, the NLU engine may determine whether to retrieve additional information from external entity-summarization database 1241, e.g., based on output of the generative model, based on detecting one or more keywords in the user's query, and/or using a separate classifier (e.g., a neural network, LLM, etc.) that is trained specifically to determine whether to retrieve additional information.

In some implementations, the NLU engine can resolve the intent(s) and/or parameter(s) based on a single utterance of a user and, in other situations, prompts can be generated based on unresolved intent(s) and/or parameter(s). In this latter situation, the generated prompts can be rendered (e.g., visually and/or audibly) to the user to receive user response(s), where the user response(s) to the rendered prompt(s) can be utilized by the NLU engine in resolving intent(s) and/or parameter(s). Optionally, the NLU engine can work in concert with a dialog manager engine (not illustrated) that determines unresolved intent(s) and/or parameter(s). For instance, the dialog manager engine can be alternatively or additionally utilized to generate the aforementioned prompt(s). In some implementations, the NLU engine can utilize one or more NLU machine learning models in determining intent(s) and/or parameter(s).

In some implementations, the chat application 102A can, but does not necessarily need to, a text-to-speech (TTS) engine 107. The TTS engine 107 can convert a text to a synthesized speech (e.g., using a particular voice), for instance, when the text includes responsive content generated in response to a spoken utterance from a user. The synthesized speech, for instance, can be generated by using one or more trained speech synthesis neural network models to process the text. The synthesized speech can be audibly rendered via hardware speaker(s) of the client computing device 10 (e.g., a stand-alone speaker) or via another device (e.g., a cell phone).

In some implementations, the client computing device 10 can include a data storage 106. The data storage 106 can store various types of files and/or data. For instance, the data storage 106 can store application data of the chat application 102A (and/or one or more additional applications), user data (e.g., one or more user profiles) of a user of the client computing device 10, and/or other metadata. The one or more additional applications can include, for example, a social media application, a video player, a note-taking application, a shopping application, a messaging application, and/or any other appropriate applications (or services), installed at (or accessible via) the client computing device 10.

The server computing device 12 can be, for example, a web server, one or more blade servers acting together to provide “cloud” infrastructure, or any other type of server as needed. In various implementations, the server computing device 12 can include cloud-based components the same as or similar to hardware and/or software components of the client computing device 1. The same or similar descriptions are omitted herein for the sake of brevity. In some implementations, the server computing device 12 (and/or the client computing device 10) can include a data storage that stores training instance(s) to train the LLM embedder 190A, and/or store the external entity-summarization database 1241.

FIG. 1B illustrates an example scenario where an entity summarization database 1241 is built and utilized in responding to a user query, in accordance with various implementations disclosed herein. As shown in FIG. 1B, a plurality of data sources 16 can be selected for generating/creating an external entity summarization database (e.g., 1241), based on one or more selection criteria such as timeliness, reputation and reliability. The plurality of data sources 16 can include, for instance, a first data source 16-1, a second data source 16-2, . . . , and an N^{th} data source 16-N (where N can be any positive integer). The N^{th} data source 16-N can be, for instance, a forum, a content-sharing platform/app that shares videos (images, natural language content, etc.), a podcast-hosting platform (e.g., that hosts podcasts), or a website (e.g., that shares shopping reviews, book reviews, movies review, or other types of reviews or content).

In some implementations, as a non-limiting example, the first data source 16-1 can include/publish a first description (e.g., review, comment, etc.) that describes one or more features of a first entity (e.g., a brand A, model B laptop) that belongs to a first entity class (e.g., “laptop”). The second data source 16-2 can include/publish a second description (e.g., review, comment, etc.) that describes one or more additional features of a second entity (e.g., a brand C, model D laptop) that belongs to the first entity class (e.g., “laptop”).

In the above non-limiting example, the first description that describes one or more features of the first entity that belongs to the first entity class and the second description that describes one or more additional features of the second entity that belongs to the first entity class can be processed using the LLM 190C, to generate a concatenated summarization description for the first entity class. For instance, a prompt can be generated to include the first description that describes feature(s) of the first entity that belongs to the first entity class, the second description that describes feature(s) of the second entity that belongs to the first entity class, and an instruction to summarize the first and second descriptions. The prompt, for instance, can be: “summarize <the first description> and <the second description>”. Such prompt can be processed as input, using the LLM 190C, to generate the concatenated summarization description for the first entity class.

Continuing with the above non-limiting example, an entry can be created in the entity summarization database 1241 to store the concatenated summarization description for the first entity class. Optionally, an embedding (may be referred to as “concatenated summarization description embedding”) can be generated for the concatenated summarization description for the first entity class (e.g., using the custom embedder 190A). The concatenated summarization description embedding can be stored in the created entry (or be stored in association with the concatenated summarization description for the first entity class). The LLM 190C can be the same as, or different from the LLM 190B.

Optionally, the concatenated summarization description for the first entity class can include a first portion identifying the first entity class, a second portion summarizing the one or more features of the first entity (that belongs to the first entity class), and a third portion summarizing the one or more additional features of the second entity (that belongs to the first entity class). In this case, optionally, the second (or third) portion can be respectively associated with a corresponding data source. For instance, the second portion can be associated with an address directing to the first description published within the first data source 16-1 and/or an identifier of the first data source 16-1. For instance, the second portion of the concatenated summarization description for the first entity class can be embedded with a URL link to the first description published within the first data source 16-1.

The third portion can be associated with an additional address directing to the second description within the second data source 16-2, and/or an identifier of the second data source 16-2. For instance, the third portion of the concatenated summarization description for the first entity class can be embedded with a URL link to direct to the second description accessible at the second data source 16-2.

In some implementations, instead of processing the first description (that describes one or more features of the first entity that belongs to the first entity class) and the second description (that describes one or more additional features of the second entity that belongs to the first entity class) together using the LLM 190C, the first description and the second description can be separately processed using the LLM 190C. For instance, a first prompt can be generated to include the first description (e.g., “summarize <the first description>”). The first prompt can be processed using the LLM 190C, to generate a summarized description for the first entity that belongs to the first entity class. An individual entry can be created to store the summarized description for the first entity that belongs to the first entity class in the external entity-summarization database 1241.

Likewise, a second prompt can be generated to include the second description (e.g., “summarize <the second description>”), and the second prompt can be processed using the LLM 190C, to generate a summarized description for the second entity that belongs to the first entity class. An additional individual entry can be created to store the summarized description for the second entity that belongs to the first entity class in the external entity-summarization database 1241.

In some implementations, optionally, feature-specific summaries can be generated based on content extracted from a data source (or multiple data sources) via keyword (e.g., entity name) monitoring/detection. For example, a description (e.g., an article) describing a first feature and a second feature of a particular entity can be detected or retrieved from a first source (e.g., a website), and a description (e.g., a comment) describing the first feature and a third feature of the particular entity can be detected or retrieved from a second source (e.g., the website or a forum). The first, second, and third features are distinct from each other. The second source can be the same as, or different from, the first source. In this case, the description describing the first feature and the second feature of the particular entity and the description describing the first feature and the third feature of the particular entity can be processed to generate a plurality of feature-specific summarized descriptions.

In the above example, the plurality of feature-specific summarized descriptions can include a first feature-specific summarized description that summarizes the first feature of the particular entity. The first feature-specific summarized description can be generated, for instance, based on processing the description describing the first and second features and the description describing the first and third features, using the LLM 190C. The plurality of feature-specific summarized descriptions can include a second feature-specific summarized description that summarizes the second feature of the particular entity. The second feature-specific summarized description can be generated, for instance, based on processing the description describing the first and second features, using the LLM 190C. The plurality of feature-specific summarized descriptions can include a third feature-specific summarized description that summarizes the third feature of the particular entity. The third feature-specific summarized description can be generated, for instance, based on processing the description describing the first and third features, using the LLM 190C. The generation and caching or storage of feature-specific summarized descriptions (see, e.g., an entry for “SUV” in FIG. 2F) in the external entity-summarization database 1241 may benefit the LLM 190C in providing a quick response when utilized to handle user queries such as “what phone has the best camera and battery performances” or “what SUV has good reliability and gas mileage”.

In some implementations, the entity summarization database 1241 can be utilized to formulate a response 15 responsive to a user query 141 that seeks information of an entity class (or in some cases, that seeks information of a particular entity). The user query 141, for instance, can be a typed input (or audible input) of “what's the smartphone with best battery performance?” The user query 141 can be received via the chat app 102A which is locally installed at (or otherwise accessible via) the client computing device 10. In some implementations, the user query 141 can be forwarded to the server computing device 12. Optionally, contextual data (such as a chat history 142) associated with the user query 141 can be retrieved and be forwarded to the server computing device 12, along with the user query 141. The contextual data associated with the user query 141 can include, for instance, a chat history 142 (or a portion thereof) associated with the user query 141 and/or a user profile of a user that provides the user query 141, etc. The chat history 142 or a portion thereof, for instance, can be content preceding the user query 141 (if there is any).

In some implementations, the user query 141 and/or the contextual data associated with the user query 141 can be processed using the custom embedder 190A, to generate a query-based embedding (e.g., “Embedding_1” as shown in FIG. 1B) for querying the entity summarization database 1241. For instance, the query-based embedding can be applied to search the entity summarization database 1241, to identify a concatenated summarization description for the first entity class that recommend one or more entities that belong to the first entity class. The concatenated summarization description for the first entity class that recommends one or more entities that belong to the first entity class can be identified based on a similarity score between a concatenated summarization description embedding (e.g., “Embedding_2” as shown in FIG. 1B) for the concatenated summarization description (for the first entity class that recommends one or more entities that belong to the first entity class) and the query-based embedding (e.g., “Embedding_1”) satisfying a predefined similarity threshold. The concatenated summarization description embedding (e.g., “Embedding_2” as shown in FIG. 1B) for the concatenated summarization description may be considered as matching the query-based embedding (e.g., “Embedding_1”).

In some implementations, the concatenated summarization description for the first entity class can be returned as a search result for the search of the entity summarization database 1241 using the query-based embedding. Alternatively or additionally, the concatenated summarization description embedding (“Embedding_2”) generated based on processing the concatenated summarization description for the first entity class (e.g., using the custom embedder 190A) can be included in the search result responsive to the search of the entity summarization database 1241 (e.g., using the query-based embedding).

In some implementations, the concatenated summarization description embedding (“Embedding_2”) can be processed using the LLM 190B to generate the response 15. The response 15 can be rendered via the chat app 102A. For instance, the LLM 190B can include a decoder that translates the concatenated summarization description embedding (“Embedding_2”) into the response 15 (e.g., in natural language).

In some implementations where the concatenated summarization description for the first entity class is returned as a search result instead of the concatenated summarization description embedding (“Embedding_2”), an input prompt can be generated based on the retrieved concatenated summarization description (e.g., a summarized recommendation text) for the first entity class. The input prompt can include, for instance, the user query 141, the retrieved concatenated summarization description for the first entity class, and/or an instruction to generate a response to the user query in view of the retrieved concatenated summarization description. For example, the input prompt can be: “generate a response to <user query 141> using <the retrieved concatenated summarization description for the first entity class>”. The input prompt can be processed, using the LLM 190B, to generate the response 15.

In some implementations, the response 15, for instance, can describe one or more features of a particular entity (and/or one or more additional entities) that belongs to the first entity class. For instance, the response 15 responsive to the user query 141 (“what's the smartphone with best battery performance?”) can be: “I recommend phone Y as it lasts about 12 hours”, “Based on reviews from forum AA, I recommend phone Y as it lasts about 12 hours”, or “Based on reviews from forum AA, I recommend phone Y as it lasts about 12 hours. See link below to view the original reviews at forum AA-URL:

forumAA.com/smartphone/comment1234567”. The format of the response 15 however, is not limited to descriptions herein.

FIG. 2A depicts an example user query, in accordance with various aspects of the present disclosure. FIG. 2B depicts an example response responsive to the user query in FIG. 2A, in accordance with various aspects of the present disclosure. FIG. 2D depicts an example entity summarization database utilized in generating a response in FIG. 2B, in accordance with various aspects of the present disclosure.

As shown in FIG. 2A, a user may provide a user query 201B via a user interface 200 of the chat app 102A that is accessible via a device 20. The user query 201B can be, for instance, “Could you recommend the best smartphone with respect to battery performance?” Optionally, it is noted that preceding the user query 201B, a chat history associated with the user query 201B can include a user input 201A of “I've searched within forum M but cannot find much useful information” that precedes the user query 201B. In this case, the user query 201B (and/or the user input 201A) can be processed using a custom embedder (e.g., 190A in FIG. 1B), to generate a query-based embedding for the user query 201B (and/or the user input 201A). The query-based embedding can be used to search an entity summarization database 220B as shown in FIG. 2D.

The entity summarization database 220B, as shown in FIG. 2D, can include multiple entries, such as an entry for a first entity (“phone X”) that belongs to a first entity class (e.g., “phone”). The entity summarization database 220B can further include an entry for a second entity (“phone E”) that belongs to the first entity class (e.g., “phone”), an entry for a third entity (“SUV A)” that belongs to a second entity class (“SUV”), an entry for a fourth entry (“basmati rice”) that belongs to a third entity class (“rice”), and an entry for a fifth entry (“short-grain Japanese rice”) that belongs to the third entity class (“rice”).

The entry for the first entity (“phone X”) can include, for instance, a summarized description for the first entity, such as: “Phone X lasts 12 hours, the best for affordable smartphone.” Optionally, the entry for the first entity (“phone X”) can include data source(s) (e.g., forum N or more) that provide one or more descriptions (e.g., reviews, posts, comments) from which the summarized description for the first entity is generated (e.g., using the custom embedder 190A). Optionally, the entry for the first entity (“phone X”) can include address(es) (URL₁₁) of the one or more descriptions accessible via the data source(s). Optionally, the entry for the first entity (“phone X”) can include a summarized description embedding e₁₁ generated based on processing the summarized description for the first entity (e.g., using the custom embedder 190A).

The entry for the second entity (“phone E”) can include, for instance, a summarized description for the second entity, such as: “phone E is known to have the best camera performance”. Optionally, the entry for the second entity (“phone E”) can include data source(s) (e.g., website B or more) that provide one or more descriptions (e.g., reviews, posts, comments) from which the summarized description for the second entity is generated (e.g., using the custom embedder 190A). Optionally, the entry for the second entity (“phone E”) can include address(es) (URL₁₂) of the one or more descriptions accessible via the data source(s). Optionally, the entry for the second entity (“phone E”) can include a summarized description embedding e₁₂ generated based on processing the summarized description for the second entity (e.g., using the custom embedder 190A). Optionally, a concatenated summarization description embedding E1 can be generated based on processing the summarized description for the first entity (e.g., “Phone X lasts 12 hours, the best for affordable smartphone”) and the summarized description for the second entity (e.g., “phone E is known to have the best camera performance”), using the custom embedder 190A.

The entry for the third entity (“SUV A”) can include, for instance, a summarized description for the third entity (“SUV A”), such as: “SUV A has so far the best gas mileage and is rated to have a reliability score of 8/10”. Optionally, the entry for the third entity (“SUV A”) can include data source(s) (e.g., source A as source for “best gas mileage” and/or source B as source for “reliability score”) that provide one or more descriptions (e.g., reviews, posts, comments) from which the summarized description for the third entity is generated (e.g., using the custom embedder 190A). Optionally, the entry for the third entity (“SUV A”) can include address(es) (URLs) of the one or more descriptions accessible via the data source(s). The address(s) stored in association with the entry for “SUV A” can include, for instance, link A that leads to the original content in source A for “best gas mileage”, and/or link B that leads to the original content in source B for “reliability score”. Optionally, the entry for the third entity (“SUV A”) can include a summarized description embedding e₂₁ generated based on processing the summarized description for the third entity (e.g., using the custom embedder 190A).

The entry for the fourth entity (“basmati rice”) can include, for instance, a summarized description for the fourth entity, such as: “The most loved type of rice in Indian food is basmati rice”. Optionally, the entry for the fourth entity (“basmati rice”) can include data source(s) (e.g., source C and/or other sources) that provide one or more descriptions (e.g., reviews, posts, comments) from which the summarized description for the fourth entity is generated (e.g., using the custom embedder 190A). Optionally, the entry for the fourth entity (“basmati rice”) can include address(es) (URL_{N1}) of the one or more descriptions accessible via the data source(s). Optionally, the entry for the fourth entity (“basmati rice”) can include a summarized description embedding e_{N1} generated based on processing the summarized description for the fourth entity (e.g., using the custom embedder 190A).

The entry for the fifth entity (“short-grain Japanese rice”) can include, for instance, a summarized description for the fifth entity, such as: “the best rice for sushi is short-grain Japanese rice”. Optionally, the entry for the fifth entity (“short-grain Japanese rice”) can include data source(s) (e.g., source D and/or other sources) that provide one or more descriptions (e.g., reviews, posts, comments) from which the summarized description for the fifth entity is generated (e.g., using the custom embedder 190A). Optionally, the entry for the fifth entity (“short-grain Japanese rice”) can include address(es) (URL_{N2}) of the one or more descriptions accessible via the data source(s). Optionally, the entry for the fifth entity (“short-grain Japanese rice”) can include a summarized description embedding e_{N2} generated based on processing the summarized description for the fifth entity (e.g., using the custom embedder 190A). Optionally, a concatenated summarization description embedding En can be generated based on processing the summarized description for the fourth entity and the summarized description for the fifth entity, using the custom embedder 190A.

In other words, the multiple entries of the entity summarization database 220B, as shown in FIG. 2D, can include a first set of entries for the first entity class, a second set of entries for the second entity class, . . . , and an Nth set of entries for an Nth entity class. The first set of entries for the first entity class can include, for instance, an entry (“Phone X lasts 12 hours, the best for affordable smartphone”) for a first entity (“phone X”) that belongs to the first entity class (“phone”)), and an entry (“phone E is known to have the best camera performance) for a second entity (“phone E”) that belongs to the first entity class.

The second set of entries for the second entity class can include, for instance, an entry (“SUV A has so far the best gas mileage and is rated to have a reliability score of 8/10”) for a third entity (“SUV A”) that belongs to the second entity class (“SUV”). The Nth set of entries for the Nth entity class can include, for instance, an entry (“The most loved type of rice in Indian food is basmati rice) for a fourth entity (“basmati rice”) that belongs to the Nth entity class (“rice”), and an entry (“the best rice for sushi is short-grain Japanese rice) for a fifth entity (“short-grain Japanese rice”) that belongs to the Nth entity class (“rice”).

In some implementations, in response to querying the entity summarization database 220B using the aforementioned query-based embedding, similarity scores can be calculated between the query-based embedding and each of the summarized description embeddings (and in some case, the concatenated summarization description embeddings, and/or feature-specific summarized description embeddings for feature-specific summarized descriptions). One or more summarized description embeddings (or in some cases, a concatenated summarization description embedding, or one or more feature-specific summarized description embeddings) having top ranked similarity score(s) can be selected/determined as matching the query-based embedding. Such summarized description embedding(s) can be processed using the LLM 190B, to generate a response to the user query.

For example, referring back to FIG. 2B, given the user query of “Could you recommend the best smartphone with respect to battery performance?”, the response 211 (“Phone X lasts 12 hours, the best for affordable smartphone”) can be generated based on processing the summarized description for the first entity (e.g., “Phone X lasts 12 hours, the best for affordable smartphone” (or the summarized description embedding e₁₁ for the summarized description for the first entity) using the LLM model 190B.

In some implementations, the response 211 (“Phone X lasts 12 hours, the best for affordable smartphone”) can be the same as the summarized description for the first entity (e.g., “Phone X lasts 12 hours, the best for affordable smartphone.”). This occurs, for instance, if the summarized description embedding e₁₁ for the summarized description for the first entity (“phone X”) is retrieved from the entity summarization database 220B, based on a similarity score between the summarized description embedding e₁₁ and the query-based embedding satisfying a predefined similarity threshold. The summarized description embedding e₁₁ for the summarized description for the first entity can be processed, for instance, using the LLM 190B (e.g., a decoder portion of the LLM 190B) to translate the summarized description embedding e₁₁ into the response 211.

In some implementations, the response 211 can be different from the summarized description for the first entity (e.g., “Phone X lasts 12 hours, the best for affordable smartphone.”), and can be, for instance, “Users from forum N recommends Phone X as it lasts 12 hours, the best among affordable smartphones”. This occurs, for instance, if an input prompt is generated based on the user query and/or the summarized description for the first entity (“phone X”). The input prompt can be, for instance, “generate a recommendation text for <user query 201B> in view of <the summarized description for the first entity>” or “generate a recommendation text for <user query 201B> in view of <the chat history 201A> and <the summarized description for the first entity>”. Such input prompt can be processed using the LLM 190B, to generate the response 211. It is noted that, the inclusion of the contextual data such as chat history or a portion thereof (e.g., 201A that precedes the user query 201B) can affect the rankings of the summarized descriptions or the summarized description embeddings thereof, and thus improves the accuracy or quality of the response 211.

In some implementations, the response 211 can include or identify a source (e.g., forum N) from which descriptions were retrieved and applied previously to generate the summarized description for the first entity (e.g., “Phone X lasts 12 hours, the best for affordable smartphone”) which is used to formulate the response 211. For instance, as shown in FIG. 2B, the response 211, when rendered in response to the user query 201B, can include a graphical user interface (GUI) element 211A. The GUI element 211A can be selectable to cause the descriptions (e.g., original reviews, post, or other types of content such as a video) which were used to generate the summarized description for the first entity to be rendered within the chat interface 200 (e.g., as an overlay). Optionally, the GUI element 211A can include/display natural language content such as “view original reviews from forum N”.

FIG. 2C depicts another example entity summarization database 220A, in accordance with various aspects of the present disclosure. As shown in FIG. 2C, the entity summarization database 220A can include multiple entries, where the multiple entries can include a first concatenated summarization description (“Phone X lasts about 12 hours, which is the best time for affordable smartphone (source: forum N; link: . . . ); phone E is known to have the best camera (source_F; link . . . )”).

Alternatively or additionally, the multiple entries can include a second concatenated summarization description for the second entity class (“SUV”) and/or an embedding E2 thereof. The second concatenated summarization description for the second entity class (“SUV”) can be, for instance, “SUV A has so far the best gas mileage (source A; link A) and is rated to have a reliability score of 8/10 (source B; link B). Alternatively or additionally, the third concatenated summarization description for the N^{th} entity class (“rice”) can be, for instance, “The most loved type of rice in Indian food is basmati rice (source C; link C); the best rice for sushi is short-grain Japanese rice (source D; link D)”.

FIG. 2E depicts a further example entity summarization database 220C utilized in generating a response in FIG. 2B, in accordance with various aspects of the present disclosure. As shown in FIG. 2E, with respect to the entity summarization database 220B in FIG. 2D, the entity summarization database 220C can further include concatenated summarization description embeddings (e.g., E1, . . . , En), in addition to summarized description embeddings such as e₁₁, e₁₂, . . . , e_{N2}.

FIG. 2F depicts an additional example entity summarization database 220D utilized in generating a response for a user query (e.g., 201B in FIG. 2B, or the aforementioned “what SUV has good mileage and reliability”), in accordance with various aspects of the present disclosure. As shown in FIG. 2F, with respect to the entity summarization database 220C in FIG. 2E, the entity summarization database 220D can include feature-specific summarization description(s) and correspondingly generated embeddings (e.g., e₂₁₁ and e₂₁₂).

Referring to FIG. 2F, the entity summarization database 220D can include an entry for the second entity class of “SUV”, where the entity class of “SUV” can be associated with the embedding E2 generated based on processing the second concatenated summarization description for the second entity class (“SUV”) using, e.g., custom embedder 190A. The entry for the second entity class of “SUV” can alternatively or additionally store the summarized description embedding e₂₁ generated based on processing the summarized description for the third entity of “SUV A” (e.g., using the custom embedder 190A).

Additionally or alternatively, the entry for the second entity class of “SUV” can store or cache a first feature-specific summarized description of a first feature of the third entity of “SUV A” and/or an embedding e₂₁₁ thereof. The first feature can be, for instance, relating to “gas mileage”, and the first feature-specific summarized description of the first feature can be “SUV A has so far the best gas mileage”. The embedding e₂₁₁ of the first feature-specific summarized description can be generated based on processing the first feature-specific summarized description using the custom embedder 190A.

The entry for the second entity class of “SUV” can store or cache a second feature-specific summarized description of a second feature of the third entity of “SUV A” and/or an embedding e₂₁₂ thereof. The second feature can be, for instance, relating to “reliability”, and the second feature-specific summarized description of the second feature can be “SUV A is rated to have a reliability score of 8/10”. The embedding e₂₁₂ of the second feature-specific summarized description can be generated based on processing the second feature-specific summarized description using the custom embedder 190A.

The generation and caching or storage of feature-specific summarized descriptions and embeddings thereof in an external entity-summarization database (e.g., 220D) may benefit a generative model (e.g., LLM 190C) in providing a quick response when utilized to handle user queries such as “what phone has the best camera and battery performances” or “what SUV has good reliability and gas mileage”.

Optionally, the embeddings in the entity summarization database(s) (e.g., 1214, 200A, 200B, 200C, 200D, and/or 200E) can be of the same length. This can be implemented based on generating those embeddings using the same embedder, e.g., embedder 190A. A user query to query the entity summarization database(s) can also be processed to generate a corresponding query embedding using the embedder 190A, so that the query embedding is of the same length as the embeddings stored in the entity summarization database, to facilitate embedding matching.

FIG. 2G depicts an example updated entity summarization database 220E based on applying an update to the entity summarization database 200B in FIG. 2D, in accordance with various aspects of the present disclosure. For example, external data sources such as review websites, review videos, podcasts with reviews, etc., may be scraped for new content. FIG. 2H depicts an example response responsive to the user query in FIG. 2A, utilizing the updated entity summarization database in FIG. 2G, in accordance with various aspects of the present disclosure.

As shown in FIG. 2G, an entry for the first entity class (“phone”) can include a first portion 251 that identifies an entity class (“phone”), a second portion 252, and a third portion 253. The second portion 252 can correspond to a summarized description of the first entity “phone X” that belongs to the entity class of “phone”, and the third portion 253 can corresponds to a summarized description of the second entity “phone E” that belongs to the entity class of “phone”. Based on a detection of a description (e.g., a long post or other content, such as a video) for an additional entity (“phone F”) being published at source_Q, the description (e.g., a long post) for the additional entity (“phone F”) can be retrieved from source_Q and summarized using the LLM 190C in FIG. 1B. The summarized description for the additional entity (“phone F”) can be, for instance, “phone F is best gaming smartphone with long-lasting battery”. Such summarized description for the additional entity (“phone F”) can be provided to the entity summarization database 220B, to generate the updated entity summarization database 220E. For instance, the entry for the first entity class (“phone”) can be updated to include a fourth portion 254. The fourth portion 254 can include the summarized description (“phone F is best gaming smartphone with long-lasting battery”) for the additional entity (“phone F”).

In this case, in response to receiving the user query 201B of “Could you recommend the best smartphone with respect to battery performance?”, a response 211′ can be generated based on querying the entity summarization database 220D. Querying the entity summarization database 220D can include: generating a query-based embedding based on processing the user query 201B and/or the preceding text 201A using the aforementioned custom embedder; comparing the query-based embedding with each of the summarized description embeddings (e.g., e₁₁, e₁₂, e₁₃, . . . e_{N1}, e_{N2}) that are accessible via the entity summarization database 220D; and determining one or more of the summarized description embeddings that match the query-based embedding.

For instance, given the user query 201B of “Could you recommend the best smartphone with respect to battery performance?”, a summarized description embedding e₁₁ and a summarized description embedding e₁₃ can be determined as matching the query-based embedding based on a similarity score between e₁₁ and the query-based embedding satisfies the predefined similarity threshold and based on another similarity score between e₁₃ and the query-based embedding satisfies the predefined similarity threshold. Optionally, the summarized description embedding e₁₁ and the summarized description embedding e₁₃ can be forwarded to a generative model (e.g., LLM 190B). The summarized description embedding e₁₁ and the summarized description embedding e₁₃ can be processed using the generative model (e.g., LLM 190B), to generate the response 211′.

Alternatively, the summarization description (“Phone X lasts about 12 hours, which is the best time for affordable smartphone”) to which the summarized description embedding e₁₁ corresponds and the summarized description (“phone F is best gaming smartphone with long-lasting battery”) to which the summarized description embedding e₁₃ corresponds can be forwarded to the generative model (e.g., LLM 190B). In this case, an input prompt can be generated based on the summarization description (“Phone X lasts about 12 hours, which is the best time for affordable smartphone”) and the summarized description (“phone F is best gaming smartphone with long-lasting battery”). For instance, the input prompt can be: “generate a recommendation based on <Phone X lasts about 12 hours, which is the best time for affordable smartphone)> and <phone F is best gaming smartphone with long-lasting battery>”.

In some implementations, the response 211′ (an updated response as compared to response 211 in FIG. 2B) can be, a combination of the summarization description (“Phone X lasts about 12 hours, which is the best time for affordable smartphone”) and the summarized description (“phone F is best gaming smartphone with long-lasting battery”). Alternatively, the response 211′ can be, different from the combination of the summarization description (“Phone X lasts about 12 hours, which is the best time for affordable smartphone”) and the summarized description (“phone F is best gaming smartphone with long-lasting battery”).

For example, as shown in FIG. 2H, the response 211′ can include natural language content of “‘Phone X lasts 12 hours and is affordable’ ‘If you are looking for a gaming phone that lasts long hours, phone F is a good choice’”. The response 211′ can include one or more selectable GUI elements such as a first selectable GUI element 211B and a second selectable GUI element 211C. The first selectable GUI element 211B can include an identifier (e.g., name) of the data source (e.g., forum N) and the second selectable GUI element 211C can include an additional identifier (e.g., name) of the data source (e.g., source Q). The first selectable GUI element 211B can be embedded with a first link to description(s) such as a product review or post from forum N. The first selectable GUI element 211B, when selected, can cause the first link to be executed, which causes the product review or post to be rendered, e.g., as an overlay, with respect to the response 211′. The second selectable GUI element 211C can be embedded with a second link to description(s) such as a video from source Q. The second selectable GUI element 211C, when selected, can cause the second link to be executed, which causes the video to be rendered, e.g., as an overlay, with respect to the response 211′.

FIG. 2I depicts user access to original content from an external data source, in accordance with various aspects of the present disclosure. As shown in FIG. 2H and FIG. 2I, a user selection of the first selectable GUI element 211B can cause an overlay 2117 to be rendered within the chat interface 200. The overlay 2117 can be displayed, for instance, with respect to the response 211′. The overlay 2117 can show a portion of a post (e.g., titled “Which phone has good battery performance?”) from Forum N. The post from Forum N includes a description 271 (“I highly recommend Phone X. Just purchased it last month, and just as advertised, it lasts 2 hours, and the price is affordable, nearly half price of . . . ”). The description 217 is processed (e.g., using a generative model such as the LLM 190C in FIG. 1B) to generate a corresponding summarized description for entity “phone X” that belongs to an entity class of “phone”. The summarized description for entity “phone X” is stored in an external entity summarization database (e.g., the entity summarization database 220B in FIG. 2D). Optionally, an embedding (e.g., e₁₁ in FIG. 2D) is generated based on processing the summarized description for entity “phone X” using an embedder (e.g., custom embedder 190A in FIG. 1B). Optionally, a slider 270 can be rendered which enables a user to scroll and view the rest portion of the post.

By monitoring update(s) to data sources from which descriptions are processed to create entries in the entity summarization database(s), such as new posts, new media content (e.g., video), new comments to existing posts, the entity summarization database(s) 1241 can be updated accordingly, e.g., to accommodate the fact that products nowadays have short life cycles and that the environments where the products are used change constantly and relatively quickly. Moreover, the LLM used to generate responses to user queries can be supplied with updated information (e.g., new or updated product reviews or recommendations) instead of outdated (and sometimes significantly outdated) information. This can reduce the chances of the LLM in generating hallucinated or inaccurate responses (or answers) as a product from last year may not be relevant or appropriate for recommendations to users. An enhanced chance in providing accurate and sound responses (e.g., recommendations or reviews to products) helps shorten the duration of interactions between a user and a computing device that implements the LLM, and as a result, reduces the consumption of computational resources and other types of resources (e.g., battery resources, network resources, etc.).

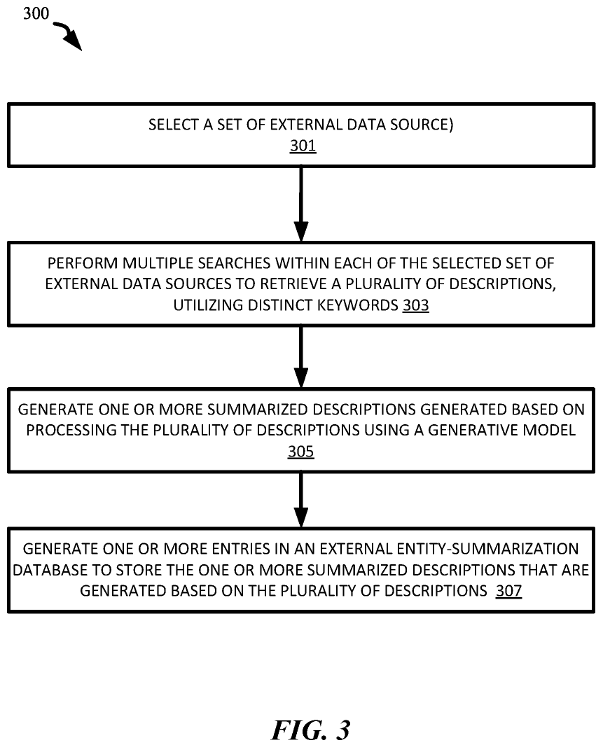

Turning now to FIG. 3, a flowchart illustrating an example method 300 of generating and/or updating entity summarization database is provided, in accordance with various aspects of the present disclosure. For convenience, the operations of the method 300 are described with reference to a system that performs the operations. This system of the method 300 includes one or more processors, memory, and/or other component(s) of computing device(s) (e.g., client computing device 10 of FIG. 1, one or more servers, and/or other computing devices). Moreover, while operations of the method 300 are shown in a particular order, this is not meant to be limiting. One or more operations may be reordered, omitted, and/or added.

In various implementations, at block 301, the system can determine or select a set of external data sources (e.g., data source_D1, data source_D2, . . . , data source_Dn, where n is a positive integer greater than or equal to “1”). The set of external data sources, for instance, can include one or more forums, one or more content-sharing platforms/apps that share videos (images, natural language content, etc.), one or more podcast-hosting platform (e.g., that hosts podcasts), and/or one or more websites (e.g., that share shopping reviews, book reviews, movies review, or other types of reviews or content).

In some implementations, the set of external data sources (D1˜Dn) can be selected from a plurality of external data sources (e.g., D1˜Dm, where m is greater than or equal to n), for instance, based on factors such as availability, ratings, and categories, timeliness, of the plurality of external data sources. The plurality of external data sources can include, for instance, a first website, a first forum, a second forum, a content-sharing platform, etc. In this example, the set of external data sources selected from the plurality of external data sources can include, for instance, the first forum and the content-sharing platform.

In various implementations, at block 303, the system can perform multiple searches within the selected set of external data sources to retrieve a plurality of descriptions (e.g., natural language descriptions such as reviews or comments, or multimodal content), where each of the multiple searches utilizes distinct keyword(s). The distinct keyword(s), for instance, can be or can include term(s) identifying a distinct entity class. In some implementations, the system can perform a first search within each external data source (from the selected set of external data sources) using a first keyword that identifies a first entity class (e.g., “book”), to identify (and/or retrieve) one or more descriptions (e.g., a post, a transcript of a video or a portion thereof, a comment, a review, etc.) each describe an entity that belongs to the first entity class. Additionally or alternatively, in some implementations, the system can perform a second search within each external data source (from the selected set of external data sources) using a second keyword that identifies a second entity class (e.g., “movie”), to identify (and/or retrieve) one or more descriptions (e.g., a post, a transcript of a video or a portion thereof, a comment, a review, etc.) each describe an entity that belongs to the second entity class.

As a non-limiting example, the one or more descriptions each describe an entity that belongs to the first entity class can include: description_A1 (e.g., one or more reviews) from source_D1 that describes entity_A1 (e.g., a first book) that belongs to the first entity class (e.g., “book”), a description_A2 (e.g., one or more reviews) from source_D1 that describes entity_A2 (e.g., a second book) that belongs to the first entity class (e.g., “book”), and description_A3 (e.g., one or more reviews) from source_D2 that describes entity_A1 (e.g., the first book) that belongs to the first entity class (e.g., “book”). In this non-limiting example, the one or more descriptions each describe an entity that belongs to the second entity class (“movie”) can include description_B1 (e.g., one or more reviews) from source_D1 that describes entity_B1 (e.g., a first movie) that belongs to the second entity class (e.g., “movie”), and description_B2 (e.g., one or more reviews) from source_D3 that describes entity_B2 (e.g., a second movie) that belongs to the second entity class (e.g., “movie”).

In various implementations, at block 305, the system can generate one or more summarized descriptions generated based on processing the plurality of descriptions using a generative model. In various implementations, at block 307, the system can generate one or more entries in an external entity-summarization database to store the one or more summarized descriptions that are generated based on the plurality of descriptions.

Continuing with the above non-limiting example, the plurality of descriptions can include, for instance, description_A1 from source_D1 that describes entity_A1 (e.g., a first book) and description_A3 from source_D2 that describes entity_A1 (e.g., the first book) can be processed using the generative model, to generate model output from which a summarized description S_A1 for the entity_A1 can be generated. The description_A2 from source_D1 that describes entity_A2 (e.g., a second book) that belongs to the first entity class (e.g., “book”), can be processed using the generative model, to generate model output from which a summarized description S_A2 for the entity_A2 can be generated. The description_B1 from source_D1 that describes entity_B1 (e.g., a first movie) that belongs to the second entity class (e.g., “movie”), can be processed using the generative model, to generate model output from which a summarized description S_B1 for the entity_B1 can be generated. The description_B2 from source_D3 that describes entity_B2 (e.g., a second movie) that belongs to the second entity class (e.g., “movie”) can be processed using the generative model, to generate model output from which a summarized description S_B2 for the entity_B2 can be generated.

Correspondingly, an entry E_A1 can be created in the external entity-summarization database to store the summarized description S_A1 for the entity_A1. An entry E_A2 can be created in the external entity-summarization database to store the summarized description S_A2 for the entity_A2. An entry E_B1 can be created in the external entity-summarization database to store the summarized description S_B1 for the entity_B1. An entry E_B2 can be created in the external entity-summarization database to store the summarized description S_B2 for the entity_B2.

Optionally, continuing with the non-limiting example above, an embedding V_A1 can be generated based on processing the summarized description S_A1 for the entity_A1 (e.g., using an embedder), and the embedding V_A1 can be stored in entry E_A1 for the entity_A1. An embedding V_A2 can be generated based on processing the summarized description S_A2 for the entity_A2 (e.g., using an embedder), and the embedding V_A2 can be stored in entry E_A2 for the entity_A2. An embedding V_B1 can be generated based on processing the summarized description S_B1 for the entity_B1 (e.g., using an embedder), and the embedding V_B1 can be stored in entry E_B1 for the entity_B1. An embedding V_B2 can be generated based on processing the summarized description S_B2 for the entity_B2 (e.g., using an embedder), and the embedding V_B2 can be stored in entry E_B2 for the entity_B2.

Optionally, entry E_A1 for the entity_A1 can include, or otherwise be associated with, an identifier of source_D1 (that provides description_A1 that describes entity_A1) and an identifier of source D2 (that provides description_A3 that describes entity_A1). For instance, the summarized description S_A1 for the entity_A1 can include a first portion (e.g., a first keyword) embedded with a link to description_A1, and include a second portion (e.g., a second keyword) embedded with a link to description_A3. Entry E_A2 for the entity_A2 can include, or otherwise be associated with, an identifier of source_D1 (that provides description_A2 that describes entity_A2), or an address (e.g., URL) to description_A2. Entry E_B1 for the entity_B1 can include, or otherwise be associated with, an identifier of source_D1 (that provides description_B1 that describes entity_B1) or an address (e.g., URL) to description_B1. Entry E_B2 for the entity_B2 can include, or otherwise be associated with, an identifier of source_D3 (that provides description_B2 that describes entity_B2) or an address (e.g., URL) to description_B2.

Alternatively or additionally, continuing with the above non-limiting example, a first prompt can be generated for the first entity class, where the first prompt can be “summarize <description_A1>, <description_A2>, and <description_A3>” or “summarize reviews from <description_A1>, <description_A2>, and <description_A3>”, etc. The first prompt can be processed as input using the generative model, to generate a concatenated summarization description CS_1 (e.g., of descriptions A1˜A3) for the first entity class. A second prompt can be generated for the second entity class, where the first prompt can be “summarize <description_B1>, <description_B2>” or “summarize reviews from <description_B1>, <description_B2>”, etc. The second prompt can be processed as input using the generative model, to generate a concatenated summarization description CS_2 (e.g., of descriptions A1˜A3) for the second entity class. Correspondingly, an entry E_1 can be created in the external entity-summarization database to store the concatenated summarization description CS_1 for the first entity class. An entry E_2 can be created in the external entity-summarization database to store the concatenated summarization description CS_2 for the second entity class.

Optionally, an embedding V_1 can be generated based on processing the concatenated summarization description CS_1 for the first entity class (e.g., using an embedder), and the embedding V_1 can be stored in the entry E_1. An embedding V_2 can be generated based on processing the concatenated summarization description CS_2 for the first entity class (e.g., using an embedder), and the embedding V_2 can be stored in the entry E_2. Optionally, the entry E_1 can store, or be associated with, source_D1 and source_D2. The entry E_2 can store, or be associated with, source_D1 and source_D3.

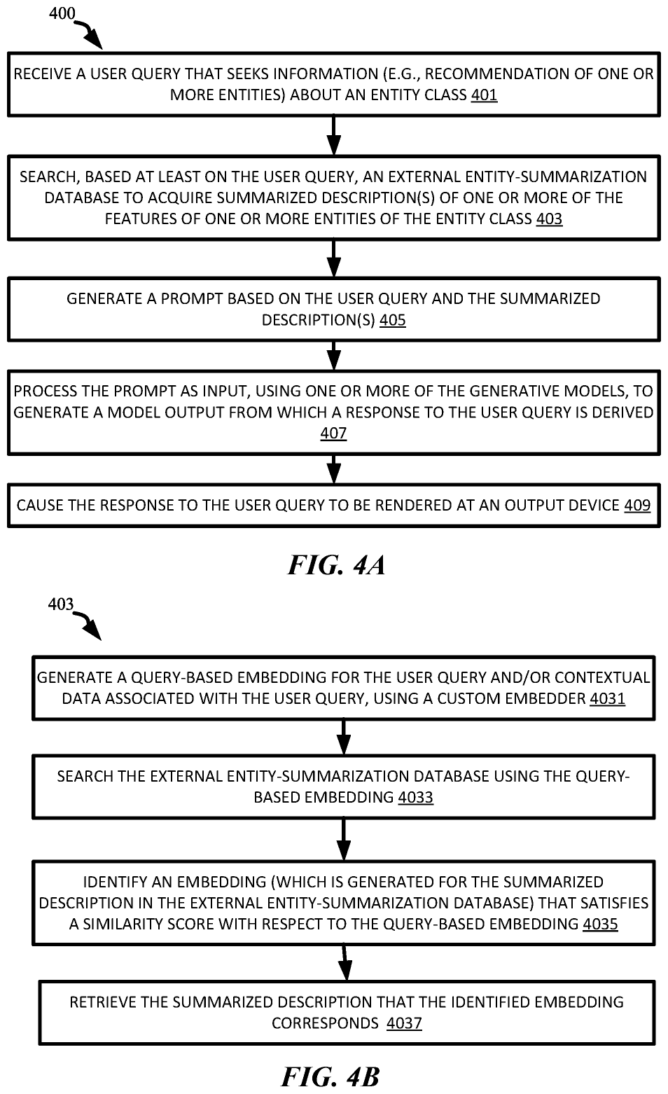

Turning now to FIG. 4A, a flowchart illustrating an example method 400 of responding to a user query using an entity summarization database is provided, in accordance with various aspects of the present disclosure. This system of the method 400 includes one or more processors, memory, and/or other component(s) of computing device(s) (e.g., client computing device 10 of FIG. 1, one or more servers, and/or other computing devices). Moreover, while operations of the method 400 are shown in a particular order, this is not meant to be limiting. One or more operations may be reordered, omitted, and/or added.

At block 401, the system receives a user query that seeks information (e.g., recommendation of one or more entities) about an entity class (or an entity that belongs to the entity class). For instance, the user query can be a typed or spoken input of “what's best smartphone in regards to battery performance” or “what is the best smartphone for photography”. As another example, the user query can be a typed or spoken input of “is phone_1 good for photography?”

In some implementations, the user query can be a spoken input received via one or more microphones of a client device and is directed to an application (e.g., a chat app, a shopping app, etc.). In some other implementations, the user query can be a typed input received via a user interface of an application (e.g., a chat app, a shopping app, etc.) that is installed at (or otherwise accessible via) the client device. The user query can be other types of input, and the present disclosure is not limited to descriptions herein.

At block 403, the system searches, based at least on the user query, an external entity-summarization database to acquire summarized description(s) of one or more of the features of one or more entities of the entity class. The external entity-summarization database includes one or more entries each storing a summarized description of one or more features of a respective entity of the entity class. The summarized description of the respective entity is generated based on summarizing one or more public descriptions that each describe multiple features of the respective entity, using one or more generative models.

In various implementations, the external entity-summarization database can be generated using method 300 as described above or other methods described in this disclosure. For example, in some implementations, the external entity-summarization database can include one or more entries each associated with a distinct entity class. For instance, the one or more entries each associated with a distinct entity class can include: a first entry for a first entity class, and/or a second entry for a second entity class that is different from the first entity class.

The first entry for the first entity class can include, for instance, a first portion that corresponds to a summarized description for a first entity that belongs to the first entity class, a second portion that corresponds to a summarized description for a second entity that belongs to the first entity class, . . . , and an Nth portion that corresponds to a summarized description for an Nth entity that belongs to the first entity class. The second entry for the second entity class can include, for instance, a first portion that corresponds to a summarized description for a 1st entity that belongs to the second entity class, a second portion that corresponds to a summarized description for a 2nd entity that belongs to the second entity class, . . . , and an Mth portion that corresponds to a summarized description for an Mth entity that belongs to the second entity class.

In some implementations, the summarized description for the first entity that belongs to the first entity class can be generated based on processing a first set of descriptions for the first entity acquired from a first set of external data sources (e.g., using an LLM). The summarized description for the second entity that belongs to the first entity class can be generated based on processing a second set of descriptions for the second entity acquired from a second set of external data sources (e.g., using the LLM) . . . . The summarized description for the Nth entity that belongs to the first entity class can be generated based on processing an Nth set of descriptions for the Nth entity acquired from an Nth set of external data sources (e.g., using the LLM).

In some implementations, the summarized description for the 1^{st} entity that belongs to the second entity class can be generated based on processing a 1^{st} set of descriptions for the first entity acquired from a 1^{st} set of external data sources (e.g., using the LLM). The summarized description for the 2^{nd} entity that belongs to the second entity class can be generated based on processing a 2^{nd} set of descriptions for the second entity acquired from a 2^{nd} set of external data sources (e.g., using the LLM) . . . . The summarized description for the Mth entity that belongs to the Mth entity class can be generated based on processing an Mth set of descriptions for the Mth entity acquired from an Mth set of external data sources (e.g., using the LLM).

Optionally, the first portion of the first entry can be associated with a first embedding generated based on processing the summarized description for the first entity that belongs to the first entity class, the second portion of the first entry can be associated with a second embedding generated based on processing the summarized description for the second entity that belongs to the first entity class, . . . , and the Nth portion of the Nth entry can be associated with an Nth embedding generated based on processing the summarized description for the Nth entity that belongs to the first entity class.

Optionally, the first portion of the first entry can be associated with a 1^{st} embedding generated based on processing the summarized description for the 1^{st} entity that belongs to the second entity class, the second portion of the 2^{nd} entry can be associated with a 2^{nd} embedding generated based on processing the summarized description for the 2^{nd} entity that belongs to the second entity class, . . . , and the Mth portion of the Mth entry can be associated with an Mth embedding generated based on processing the summarized description for the Mth entity that belongs to the second entity class.

In some other implementations, the external entity-summarization database can include one or more entries each associated with a distinct entity. The one or more entries each associated with a distinct entity can include, or instance, a first entry associated with a first entity that belongs to a first entity class, a second entry associated with a second entity that belongs to the first entity class, and a third entry associated with a third entity that belongs to a second entity class that is different from the first entity class.

The first entry associated with the first entity that belongs to the first entity class can include a summarized description for the first entity that belongs to the first entity class, and/or an embedding thereof. The second entry associated with the second entity that belongs to the first entity class can include a summarized description for the second entity that belongs to the first entity class, and/or an embedding thereof. The third entry associated with the third entity that belongs to the second entity class can include a summarized description for the third entity that belongs to the second entity class, and/or an embedding thereof. It is noted that descriptions of the external entity-summarization database are not limited to the present disclosure, and can be any applicable descriptions.

In various implementations, referring to FIG. 4B, the system searches, based at least on the user query, the external entity-summarization database by: using a custom embedder to generate a query-based embedding for the user query and/or contextual data associated with the user query (block 4031); searching the external entity-summarization database using the query-based embedding (block 4033); identifying an embedding (which is generated for the summarized description in the external entity-summarization database) that satisfies a similarity score with respect to the query-based embedding (block 4035); and/or retrieving the summarized description that the identified embedding corresponds (block 4037).

It is noted that, in some implementations, one or more embeddings can be identified as respectively satisfying the similarity score with respect to the query-based embedding. In this case, one or more summarized descriptions each correspond to a respective embedding from the one or more embeddings can be identified, and the one or more summarized descriptions (and/or the one or more embeddings) can be retrieved for subsequent processing (e.g., formulation of a prompt to be processed using an LLM).

At block 405, the system generates a prompt based on the user query and the summarized description(s) at block 403. For instance, the user query can be “what is the smart phone with the best battery performance”, and the summarized description at block 403 can be “phone Y is a good smartphone that lasts about 12 hours, the best battery performance so far” (which is generated based on a post from forum X). In this case, a prompt can be “generate a response based on <the summarized description>”, such as “generate a response based on the summarized description of ‘phone Y is a good smartphone that lasts about 12 hours, the best battery performance so far’” or “generate a response based on the summarized description of ‘phone Y is a good smart phone that lasts about 12 hours, the best battery performance so far’ from forum X”, etc.

As another example, the user query can be “what is the smart phone with the best battery performance”, and the summarized description(s) at block 403 can be “Forum X provides that phone Y is a good smartphone that lasts about 12 hours, the best battery performance so far; Content-sharing platform C provides that phone Z is the best gaming phone that lasts 18 hours” (which is generated based on a post from forum X). In this case, a prompt can be generated as “generate a response based on: Forum X provides that phone Y is a good smart phone that lasts about 12 hours, the best battery performance so far; Content-sharing platform C provides that phone Z is the best gaming phone that lasts 18 hours.”

At block 407, the system processes the prompt as input, using one or more of the generative models, to generate a model output from which a response to the user query is derived.

For instance, given the prompt of “generate a response based on the summarized description of ‘phone Y is a good smartphone that lasts about 12 hours, the best battery performance so far’ from forum X”, a response such as “I recommend phone Y as it lasts about 12 hours” can be generated. As another example, given the prompt of “generate a response based on: Forum X provides that phone Y is a good smartphone that lasts about 12 hours, the best battery performance so far; Content-sharing platform C provides that phone Z is the best gaming phone that lasts 18 hours”, a response such as “I recommend phone Y as it lasts about 12 hours. Phone Z could also be a good choice if you want a gaming smartphone” can be generated.

Optionally, the response to the user query generated using the generative models, can identify source(s) used to formulate the response. For instance, given the response of “I recommend phone Y as it lasts about 12 hours” generated based on the summarized description of ‘phone Y is a good smart phone that lasts about 12 hours, the best battery performance so far’ from forum X″, the response can include or otherwise be associated with an identifier of the data source-“forum X”. Alternatively or additionally, the response can include or otherwise be associated with an address (URL) of the summarized description of ‘phone Y is a good smart phone that lasts about 12 hours, the best battery performance so far’ accessible within forum X.

At block 409, the system causes the response to the user query to be rendered at an output device. For instance, the response to the user query can be rendered within an application (e.g., the chat app, web-based shopping app) of the client device. Optionally, the response can be embedded with the address (URL) of the summarized description of ‘phone Y is a good smart phone that lasts about 12 hours, the best battery performance so far’ accessible within forum X. In this case, the response can be selectable, and if selected, can cause the URL of the summarized description to be executed, which causes the summarized description of ‘phone Y is a good smart phone that lasts about 12 hours, the best battery performance so far’ to be rendered as an overlay with respect to the response (e.g., in an non-overlapping position, or the overlay can be movable and removed from display based on one or more user inputs).

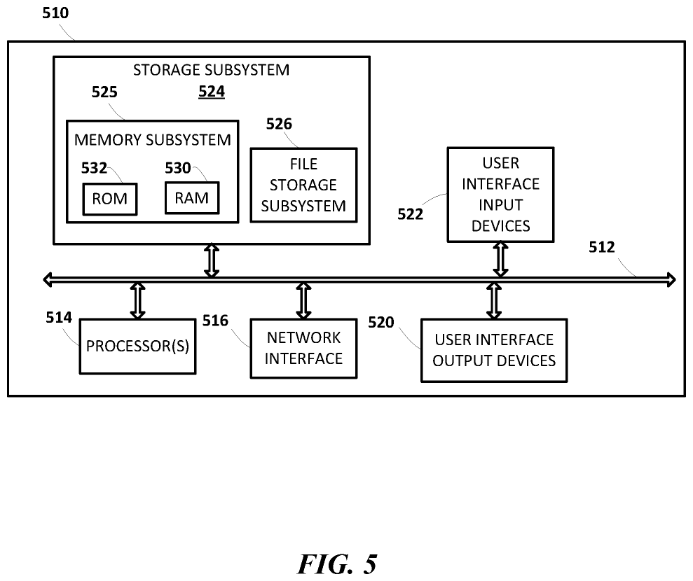

Turning now to FIG. 5, a block diagram of an example computing device 510 that may optionally be utilized to perform one or more aspects of techniques described herein is depicted. In some implementations, one or more of a client device, cloud-based LLM-based assistant component(s), and/or other component(s) may comprise one or more components of the example computing device 510.

Computing device 510 typically includes at least one processor 514 which communicates with a number of peripheral devices via bus subsystem 512. These peripheral devices may include a storage subsystem 524, including, for example, a memory subsystem 525 and a file storage subsystem 526, user interface output devices 520, user interface input devices 522, and a network interface subsystem 516. The input and output devices allow user interaction with computing device 510. Network interface subsystem 516 provides an interface to outside networks and is coupled to corresponding interface devices in other computing devices.

User interface input devices 522 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 510 or onto a communication network.

User interface output devices 520 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 510 to the user or to another machine or computing device.

Storage subsystem 524 stores programming and data constructs that provide the functionality of some or all of the modules described herein. For example, the storage subsystem 524 may include the logic to perform selected aspects of the methods disclosed herein, as well as to implement various components depicted in FIG. 1.

These software modules are generally executed by processor 514 alone or in combination with other processors. Memory 525 used in the storage subsystem 524 can include a number of memories including a main random access memory (RAM) 530 for storage of instructions and data during program execution and a read only memory (ROM) 532 in which fixed instructions are stored. A file storage subsystem 526 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 526 in the storage subsystem 524, or in other machines accessible by the processor(s) 514.

Bus subsystem 512 provides a mechanism for letting the various components and subsystems of computing device 510 communicate with each other as intended. Although bus subsystem 512 is shown schematically as a single bus, alternative implementations of the bus subsystem 512 may use multiple busses.

Computing device 510 can be of varying types including a workstation, server, computing cluster, blade server, server farm, or any other data processing system or computing device. Due to the ever-changing nature of computers and networks, the description of computing device 510 depicted in FIG. 5 is intended only as a specific example for purposes of illustrating some implementations. Many other configurations of computing device 510 are possible having more or fewer components than the computing device depicted in FIG. 5.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

Some other implementations disclosed herein recognize that training a generative model can require a significant quantity (e.g., millions) of training instances. Due to the significant quantity of training instances needed, many training instances will lack input and/or output properties that are desired when the generative model is deployed for utilization. For example, some training instance outputs for an LLM can be undesirably grammatically incorrect, undesirably too concise, undesirably too robust, etc. Also, for example, some training instance inputs for an LLM can lack desired contextual data such as user attribute(s) associated with the input, conversational history associated with the input, etc. As a result of many of the LLM training instances lacking desired input and/or output properties, the LLM will, after training and when deployed, generate many instances of output that likewise lack the desired output properties.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more transitory or non-transitory computer readable storage media storing computer instructions executable by one or more processors to perform any of the aforementioned methods. Some implementations also include a computer program product including instructions executable by one or more processors to perform any of the aforementioned methods.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, and/or method described herein. In addition, any combination of two or more such features, systems, and/or methods, if such features, systems, and/or methods are not mutually inconsistent, is included within the scope of the present disclosure.

What is claimed is:

1. A method implemented using one or more processors, the method comprising:
receiving a user query that seeks information about an entity class;
searching, based at least on the user query, an external entity-summarization database to acquire a summarized description of one or more of the features of one or more entities of the entity class,
wherein the external entity-summarization database includes one or more entries each storing a summarized description of one or more features of a respective entity of the entity class, and
wherein the summarized description of the respective entity is generated based on summarizing one or more public descriptions that each describe multiple features of the respective entity, using one or more generative models;
generating a prompt based on the user query and the summarized description of one or more features of the entity;
processing the prompt as input, using one or more of the generative models, to generate a model output from which a response to the user query is derived; and
causing the response to the user query to be rendered at an output device.

2. The method of claim 1, wherein the user query seeks a recommendation of one or more entities of the entity class, and wherein the response to the user query includes a recommendation of one or more particular entities of the entity class.

3. The method of claim 2, wherein:
the external entity-summarization database identifies one or more data sources for the one or more public descriptions, respectively; and
the one or more data sources are associated with the summarized description for the respective entity.

4. The method of claim 2, wherein the rendered response to the user query presents a particular data source for the recommendation.

5. The method of claim 4, wherein the rendered response to the user query includes a selectable element that, when selected, causes the particular data source to be rendered.

6. The method of claim 1, wherein the one or more public descriptions include a first public review that reviews the respective entity from a public data source, and a second public review that reviews the respective entity from an additional public data source that is different from the public data source.

7. The method of claim 1, wherein searching, based at least on the user query, the external entity-summarization database to acquire the summarized description of the entity comprises:
generating a first numeric embedding based on the user query and/or context data associated with the user query; and
searching the external entity-summarization database using the first numerical embedding, to identify the summarized description of the entity.

8. The method of claim 7, wherein searching the external entity-summarization database using the first numerical embedding comprises:
for each respective summarized description in the external entity-summarization database, calculate a distance between the first numeric embedding and a numeric embedding for the respective summarized description; and
selecting one summarized description from the external entity-summarization database that satisfies a distance threshold as the summarized description of the entity.

9. The method of claim 7, wherein
the user query is received during an interactive chat; and
the context data associated with the user query includes at least a portion of a chat history of the interactive chat that precedes the user query.

10. The method of claim 1, wherein the external entity-summarization database includes a respective numeric embedding for the summarized description for the respective entity, stored in association with the summarized description for the respective entity.

11. The method of claim 1, wherein the generative model is trained to summarize reviews from one or more public data sources.

12. The method of claim 11, wherein the external entity-summarization database is updated in real-time based on detection of an update to the reviews published at the one or more public data sources.

13. The method of claim 1, wherein searching, based at least on the user query, the external entity-summarization database is performed in response to the user query being classified as a query requesting recommendation of one or more entities for an entity class, or in response to determining that the user query includes one or more keywords.

14. The method of claim 1, wherein the prompt based on the user query and the summarized description of one or more features of the entity includes an instruction to generate a response to the user query utilizing the external entity-summarization database if no satisfying response is generated using inherent knowledge of the generative models.

15. A method implemented using one or more processors, the method comprising:
receiving a user query that seeks information about an entity class;
generating, based at least on the user query, a query-based embedding that semantically represents at least the user query;
searching an external entity-summarization database using the query-based embedding to identify a summarized description embedding that matches the query-based embedding, wherein the external entity-summarization database stores one or more summarized descriptions each for a distinct entity and one or more summarized description embeddings each generated from a respective one of the one or more summarized descriptions;
processing the summarized description embedding, using a generative model, to generate a response to the user query, wherein the response includes a recommendation to a particular entity that the summarized description embedding corresponds; and
causing the response to be rendered.

16. The method of claim 15, wherein the generative model is fine-tuned using one or more training instances, and wherein the one or more training instances include a first training instance that includes:
a first prompt that includes a first instruction to use a summarized description from the external entity-summarization database to generate recommendations for a first user query that seeks recommendation of one or more entities for a particular entity class, as first training instance input; and
a first ground truth response that includes a recommendation to a particular entity that belongs to the particular entity class, as first training instance output.

17. The method of claim 15, wherein the one or more training instances include a second training instance that includes:
a second prompt that includes a second instruction to generate recommendations for a second user query not seeking recommendation, as second training instance input; and
a second ground truth response that includes a response to the second user query, as second training instance output.

18. The method of claim 15, wherein the response to the user query includes an identifier of a data source associated with the summarized description embedding that matches the query-based embedding.

19. The method of claim 15, wherein the one or more summarized descriptions are generated based on processing descriptions from one or more public data sources.

20. A system comprising one or more processors and memory storing instructions that, when executed by the one or more processors, cause the one or more processors to perform operations of:
receiving a user query that seeks information about an entity class;
searching, based at least on the user query, an external entity-summarization database to acquire a summarized description of one or more of the features of one or more entities of the entity class,
wherein the external entity-summarization database includes one or more entries each storing a summarized description of one or more features of a respective entity of the entity class, and
wherein the summarized description of the respective entity is generated based on summarizing one or more public descriptions that each describe multiple features of the respective entity, using one or more generative models;
generating a prompt based on the user query and the summarized description of one or more features of the entity;
processing the prompt as input, using one or more of the generative models, to generate a model output from which a response to the user query is derived; and
causing the response to the user query to be rendered at an output device.
